(19) United States
(12) Patent Application Publication
(10) Pub. No.: US 2026/0255339 A1
(43) Pub. Date: Aug. 27, 2026

(54) METHODS FOR ASSOCIATING UPLINK PARAMETERS TO TRPS FOR MULTI-DCI BASED MULTI-TRP OPERATION

(71) Applicant: Telefonaktiebolaget LM Ericsson (publ), Stockholm (SE)

(72) Inventors: Siva MURUGANATHAN, Stittsville (CA); Claes TIDESTAV, Bâlsta (SE); Helka-Liina MÄÄTTÄNEN, Espoo (FI); Shiwei GAO, Nepean (CA)

(73) Assignee: Telefonaktiebolaget LM Ericsson (publ), Stockholm (SE)

(21) Appl. No.: 19/471,371

(22) PCT Filed: Apr. 4, 2024
(86) PCT No.: PCT/IB2024/053287

§ 371 Date: Sep. 30, 2025

Related U.S. Application Data
(60) Provisional application No. 63/494,151, filed on Apr. 4, 2023.

(51) Int. Cl. H04W 72/1263; H04L 27/26

(52) U.S. Cl. CPC H04W 72/1263; H04L 27/261

(57) ABSTRACT

A method performed by a User Equipment (UE) comprises receiving first and second Downlink Control Informations (DCIs) in first and second Control Resource Sets (CORESETs) associated to first and second CORESET pool indices, respectively The first and second CORESET pool indies are associated to respective first and second time advanced group (TAG) identifiers (IDs), the first and second DCIs are for respective first and second Physical Uplink Shared Channels (PUSCHs), the UE is configured with first and second Sounding Reference Signal (SRS) resource sets that are associated to the first and second CORESET pool indices respectively, and SRS Resource Indicator (SRI) fields in the first and second DCIs indicate respective SRS resources in the first and second SRS resource sets. The method further comprises transmitting the first and second PUSCHs in accordance with the first and second DCIs and the first and second TAG IDs, respectively.

### RELATED APPLICATIONS

This application claims the benefit of provisional patent application Ser. No. 63/494,151, filed Apr. 4, 2023, the disclosure of which is hereby incorporated herein by reference in its entirety.

### TECHNICAL FIELD

The present disclosure relates to multi-Transmission and Reception Point (TRP) uplink transmission in a cellular communications network.

### BACKGROUND

Third Generation Partnership Project (3GPP) New Radio (NR) uses Cyclic Prefix Orthogonal Frequency Division Multiplexing (CP-OFDM) in both downlink (DL) (i.e. from a network node or base station (gNB) to a User Equipment (UE)) and uplink (UL) (i.e. from UE to gNB). Discrete Fourier Transform (DFT) spread Orthogonal Frequency Division Multiplexing (OFDM) is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kilohertz (kHz), there is only one slot per subframe, and each slot consists of 14 OFDM symbols as illustrated in FIG. 1, which illustrates the NR time-domain structure with 15 kHz subcarrier spacing.

Data scheduling in NR is typically in slot basis, an example is shown in FIG. 1 with a 14-symbol slot, where the first two symbols contain Physical Downlink Control Channel (PDCCH) and the rest contains physical shared data channel, either Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings is given by

$$\frac{1}{{2}^{μ}} ms .$$

In the frequency domain, a system bandwidth is divided into Resource Blocks (RBs), each corresponding to twelve (12) contiguous subcarriers. The RBs are numbered starting with zero (0) from one end of the system bandwidth. The basic NR physical time-frequency resource grid is illustrated in FIG. 2, where only one RB within a 14-symbol slot is shown. One OFDM subcarrier during one OFDM symbol interval forms one Resource Element (RE).

Downlink transmissions to a UE can be dynamically scheduled by sending Downlink Control Information (DCI) with a DL DCI format on PDCCH. The DCI contains scheduling information such as time and frequency resource, modulation and coding scheme, etc. The user data is carried on PDSCH. The UE first detects and decodes PDCCH and, if the decoding is successful, the UE then decodes the corresponding PDSCH according to the scheduling information in the DCI.

Similarly, uplink data transmission can be dynamically scheduled using a UL DCI format on PDCCH. A UE first decodes an uplink grant in the DCI and then transmits data over PUSCH according to the control information contained in the uplink grant such as modulation order, coding rate, uplink resource allocation, etc.

In addition to dynamic scheduling, semi-persistent transmission of PUSCH using Configured Grants (CGs) is also supported in NR. There are two types of CG based PUSCH defined in NR Release 15. In CG type 1, a periodicity of PUSCH transmission as well as the time domain offset are configured by Radio Resource Control (RRC). In CG type 2, a periodicity of PUSCH transmission is configured by RRC and then the activation and release of such transmission is controlled by DCI, i.e., with a PDCCH.

### 1 DL Antenna Quasi Co-Location

Several signals can be transmitted from different antenna ports of a same base station. These signals can have the same large-scale properties such as Doppler shift/spread, average delay spread, or average delay. These antenna ports are then said to be Quasi Co-Located (QCL).

If the UE knows that two antenna ports are QCL with respect to a certain parameter (e.g., Doppler spread), the UE can estimate that parameter based on one of the antenna ports and apply that estimate for receiving signal on the other antenna port.

An antenna port is defined by a Reference Signal (RS) in NR; hence QCL relations between antenna ports are described by QCL relations between a source RS and a target RS. In NR, four types of QCL relations between a source RS and a target RS were defined as follows:
Type A: {Doppler shift, Doppler spread, average delay, delay spread}
Type B: {Doppler shift, Doppler spread}
Type C: {average delay, Doppler shift}
Type D: {Spatial Rx parameter}

Information about what assumptions can be made regarding QCL is signaled to the UE from the network via Transmit Configuration Indicator (TCI) states.

Each TCI state contains QCL information, i.e., one or two source DL RSs and the associated QCL type. The source DL RS can be a Channel State Information Reference Signal (CSI-RS) or a Synchronization Signal (SS) and Physical Broadcast Channel (PBCH) (SS/PBCH) block. If two source RSs are configured, one of them is associated with QCL type D. For example, a TCI state may contain {CSI-RS1, QCL Type A} and {CSI-RS2, QCL Type D}, which means the UE can derive Doppler shift, Doppler spread, average delay, delay spread from CSI-RS1 and Spatial Rx parameter (i.e., the Receive (RX) beam to use) from CSI-RS2.

In NR Release 15 and Release 16, a list of TCI states can be RRC configured for PDSCH and up to eight (8) TCI states from the list may be activated by a Medium Access Control (MAC) Control Element (CE). The up to eight (8) activated TCI states are mapped to up to eight (8) TCI codepoints, where each TCI codepoint can contain one of the activated TCI states for PDSCH transmission from a single Transmission and Reception Point (TRP) and two of the activated TCI states for PDSCH transmission from two TRPs. For dynamically scheduled PDSCH, the associated TCI state(s) is indicated in a TCI codepoint of the corresponding DCI scheduling the PDSCH.

For PDCCH, each Control Resource Set (CORSET) is RRC configured with a list of TCI states, and one of the list of TCI states is activated by a MAC CE. TCI state for a PDCCH is determined by the TCI state activated for a CORESET in which the PDCCH is transmitted.

For periodic CSI-RS, the corresponding TCI state is RRC configured in each CSI-RS resource. For semi-persistent CSI-RS, the associated TCI state is indicated in the corresponding activation MAC CE. For aperiodic CSI-RS, the TCI state is RRC configured in the corresponding aperiodic Channel State Information (CSI) trigger state.

### 2 Spatial Relations for UL Channels/Signals

Spatial relation is used in NR to refer to a spatial relationship between an UL channel or signal and another previously transmitted UL RS or previously received DL RS. The UL channel or signal can be a Physical Uplink control Channel, PUCCH, a PUSCH, or a Sounding Reference Signal (SRS), and the DL RS can be a CSI-RS or SS/PBCH Block (SSB). The UL RS is a periodic Sounding Reference Signal (SRS). The DL RS and UL RS can be in the same serving cell as the UL channel or signal or in a different serving cell than the UL channel or signal.

If an UL signal or channel is spatially related to a DL RS, it means that the UE should transmit the UL signal or channel using a same spatial filter as that used previously for receiving the DL RS. The spatial filter can be an antenna beam. The DL RS is also referred to as the spatial filter reference signal. If an UL signal or channel is spatially related to a UL RS, then the UE should apply the same spatial filter used previously for transmitting the UL RS for transmitting the UL signal or channel.

In NR Release 15 and Release 16, spatial relation is configured separately for PUCCH, PUSCH, and SRS. For PUCCH, each PUCCH resource can be RRC configured with up to eight (8) spatial relations and one of them can be activated by a MAC CE. Each PUCCH spatial relation information contains also a pathloss RS for PUCCH power control purpose.

For SRS, each SRS resource can be RRC configured with an SRS spatial relation. The SRS spatial relation may be updated by MAC CE.

For PUSCH, the spatial relation is the same as that of the associated SRS resource.

### 3 Release 17 Unified TCI State Framework for a Single TRP

In 3GPP Release 17, a new unified TCI state framework was introduced, which aims to streamline the indication of transmit/receive spatial filter (and other QCL properties) to the UE by letting a single TCI state (identified by TCI-StateID_r17) indicate QCL properties for multiple different DL and/or UL signals/channels.

The new unified TCI state framework can include three stages of TCI state indication for all or a subset of DL and UL channels/signals. In the first stage, RRC is used to configure a list of TCI states. In the second stage, one or more of the RRC configured TCI states are activated via MAC-CE signaling and mapped to different TCI codepoints of a TCI field in DCI. Finally, in the third stage, DCI signaling is used to select one of the activated TCI states (or two TCI states in case separate TCI states are used for DL channels/signals and UL channels/signals).

Both Joint DL/UL TCI and separate DL/UL TCI are supported in NR Release 17. For Joint DL/UL TCI, a single TCI state is used to determine a transmit/receive spatial filter for both DL signals/channels and UL signals/channels. For Separate DL/UL TCI, one DL TCI state is used to indicate a receive spatial filter for DL signals/channels and a separate UL TCI state is used to indicate a transmit spatial filter for UL signals/channels.

For PDCCH and dynamically scheduled PDSCH, if a UE is provided TCI-StateID_r17, a DM-RS antenna port for PDCCH receptions in a CORESET, other than a CORESET with index 0, associated only with UE-specific Search Space (USS) sets and/or Type3-PDCCH Common Search Space (CSS) sets, and a Demodulation Reference Signal (DM-RS) antenna port for PDSCH receptions scheduled by DCI formats provided by PDCCH receptions in the CORESET are quasi co-located with reference signals provided by the indicated TCI-State-r17.

If a UE is provided with a higher layer parameter useIndicatedTCIState for a CORESET, other than a CORESET with index 0, associated only with CSS sets other than Type3-PDCCH CCS sets, and if useIndicatedTCIState is set as enabled, a DM-RS antenna port for PDCCH receptions in the CORESET and a DM-RS antenna port for PDSCH receptions scheduled by DCI formats provided by PDCCH receptions in the CORESET are quasi co-located with reference signals provided by the indicated TCI-state-r17.

When the UE is configured with TCI-State(s) with tci-Stateld_r17 for UL, the UE shall perform PUCCH transmission and PUSCH transmission corresponding to a Type 1 configured grant or a Type 2 configured grant or a dynamic grant according to the RS configured with qcl-Type set to ‘typeD’ of the indicated TCI-State with tci-Stateld_r17.

If an SRS resource [set] is configured with useIndicatedTCIState, the UE shall transmit the target SRS resource(s) within the SRS resource set according to the RS configured with qcl-Type set to ‘typeD’ in SourceRs-Info-r17 of the indicated TCI-State with tci-Stateld_r17.

The RS can be a CSI-RS resource in a NZP-CSI-RS-ResourceSet configured with higher layer parameter repetition, a CSI-RS resource in an NZP-CSI-RS-ResourceSet configured with higher layer parameter trs-Info or, in case TCI-State with tci-Stateld_r17 is for UL only, an SRS resource with the higher layer parameter usage set to ‘beamManagement’, or SS/PBCH block associated with the same or different PCI from the PCI of the serving cell.

### 4 Multi-DCI Scheduling in Release 16

In NR Release 16, multi-DCI based DL and UL scheduling was introduced, in which a UE may receive two DCI formats, a first DCK format and a second DCI format, carried by two PDCCHs, a first PDCCH and a second PDCCH, in two CORESETs, a first CORESET and a second CORESET, respectively, in a slot. The first and second CORESETs are associated with a first and second CORESET pool indices. The first and second DCI formats schedule a first and second PDSCHs transmitted from a first and second TRPs, respectively. It is assumed that the time difference between the two TRPs are very small and within the Cyclic Prefix (CP) so that a common DL and UL timing is used for both TRPs.

An example is shown in FIG. 3, where PDCCH 1 is received in CORESET 1 with CORESET pool index=0 scheduling PDSCH1 from TRP1 while PDCCH 2 is received in CORESET 2 with CORESET pool index=1 scheduling PDSCH2 from TRP2. The two PDSCHs may be fully overlapping, partially overlapping, or non-overlapping in time. The Hybrid Automatic Repeat Request (HARQ) Acknowledgements (ACKs), or HARQ-ACKs, associated with PDSCH1 and PDSCH2 are carried in PUCCH1 and PUCCH2, respectively, which are non-overlapping in time and are transmitted towards TRP1 and TRP2, respectively.

Similarly, a PUSCH towards TRP1 can be scheduled by a DCI format carried in a PDCCH in CORESET 1, and a PUSCH towards TRP2 can be scheduled by a DCI format carried in a PDCCH in CORESET 2. An example is shown in FIG. 4, where PDCCH 3 in CORESET 1 with CORESET pool index=0 scheduling PUSCH1 from TRP1 while PDCCH 4 in CORESET 2 with CORESET pool index=1 scheduling PUSCH2 from TRP2. PUSCH1 and PUSH2 are non-overlapping in time.

For multi-DCI multi-TRP operation, a UE needs to be configured with two CORESET pools, each associated with a TRP. Each CORESET pool is a collection of CORESETs configured with a same CORESET pool index.

### 5 Time Alignment and Uplink Synchronization in NR

Different UEs in a same serving cell may be located at different locations within the cell and thus have different distances to the base station (e.g., NR gNB). A UE in NR typically acquires DL slot and symbol timing based on a SSB during cell search and transmits in the UL a Physical Random Access Channel (PRACH) preamble associated with the SSB towards the base station using the DL timing as a reference. Due to round trip propagation delay, the PRACH may be received at the base station with a time offset with respect to the expected UL timing at the base station. A timing correction is then sent from the base station to the UE in a Random Access Channel (RACH) Response (RAR) message (also referred to as a Random Access Response or RAR) for the UE. The timing correction is referred to as a Timing Advance (TA), which is used to compensate the round trip propagation delay such that the subsequent UL channels or signals can reach the base station at the desired UL slot or symbol time.

An example is shown in FIG. 5, where to achieve UL time alignment at the base station a time advance of N_{TA}=2τ is needed for UL transmissions at the UE with respect to the DL timing at the UE to compensate the UL time offset due to the propagation delay t.

Note that the UL symbol or slot timing at a base station may be shifted with respect to the DL timing by a configurable time offset. In that case, the UE may be configured with a fixed time advance offset N_{TA,offset} and N_{TA} is applied in addition to the fixed time advance offset N_{TA,offset}, i.e., the total applied time advance is N_{TA,offset}+N_{TA}.

When the UE has a connection to several different serving cells, the same TA value can sometimes be used for more than one of those cells, e.g., due to those cells being co-located and thus always having the same distance to the UE. Such cells can then be configured as belonging to the same Timing Advance Group (TAG). The configuration of TAGs is done per cell group, i.e., serving cells may be configured as belonging to the same TAG only if they belong to the same cell group (Master Cell Group (MCG) or Secondary Cell Group (SCG)).

When the UE does not perform any UL transmissions for some time in a serving cell, the TA value that the UE used earlier may no longer be accurate, e.g., due to the UE having moved and thus having a different propagation delay. In that case, if the UE performs an UL transmission using the latest received TA value, the UL transmission may reach the base station outside the receive window and thus not be correctly received by the base station. The transmission may then even interfere with other UL transmissions (from other UEs). A timer timeAlignmentTimer is therefore configured for each TAG to indicate how long the UE can consider itself to be uplink time aligned to serving cells belonging to the associated TAG without receiving any updates to the TA value. The timeAlignmentTimer thus indicates a time duration within which the UE may consider a received TA value as valid. If the UE does not receive an updated TA value before timeAlignmentTimer expires, the UE is no longer UL synchronized to the serving cells belonging to the corresponding TAG. The details are described in section 9.2.9 of 3GPP Technical Specification (TS) 38.300 (see, e.g., V16.12.0 and V17.4.0).

Except the initial TA, which is carried in a RACH response message, regular TAs during time alignment maintenance are carried in a time advance command MAC CE as shown in FIG. 6 (reproduced from 3GPP TS 38.321, see, e.g., V16.11.0 and V17.4.0), where it consists of
TAG Identity (TAG ID): This field indicates the TAG Identity of the addressed TAG. The TAG containing the Special Cell (SpCell) (i.e., a special cell which can be a primary cell in MCG or SCG, where a primary cell supports PUCCH transmission and contention-based Random Access, and is always activated) has the TAG Identity 0. The length of the field is 2 bits;
Timing Advance Command: This field indicates the index value T_{A} (0, 1, 2 . . . 63) used to control the amount of timing adjustment that MAC entity has to apply (as specified in TS 38.213). The length of the field is 6 bits.

According to 3GPP TS 38.213 (see, e.g., V16.13.0 or V17.5.0), upon reception of a timing advance command for a TAG, the UE adjusts uplink timing for PUSCH/SRS/PUCCH transmission on all the serving cells in the TAG based on a value N_{TA,offset} that the UE expects to be same for all the serving cells in the TAG and based on the received timing advance command where the uplink timing for PUSCH/SRS/PUCCH transmissions is the same for all the serving cells in the TAG.

For a SCS of 2^{μ}·15 kHz, the timing advance command, TA, for a TAG indicates the change of the uplink timing relative to the current uplink timing for the TAG in multiples of 16·64·T_{c}/2^{μ}, where T_{c}=1/(Δfₘₐₓ·N_{f}), Δfₘₐₓ=480·103 Hz, and N_{f}=4096.

A timing advance command in case of random access response for a TAG indicates N_{TA} values by index values of T_{A}=0, 1, 2, . . . , 3846, where an amount of the time alignment for the TAG with subcarrier spacing (SCS) of 2^{μ}·15 KHz is N_{TA}=T_{A}·16·64/2^{μ} and is relative to the SCS of the first uplink transmission from the UE after the reception of the random access.

In other cases, a timing advance command, T_{A}, for a TAG indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+ (T_{A}−31)·16·64/2^{μ}.

Each serving cell configuration can have a TAG identifier associated, e.g., SpCell and/or an SCell of the cell group. Two serving cells having configured the same TAG identifier will be assumed by the UE to have the same time alignment timer and belong to the same Time Alignment Group.

### 5.1 Uplink Time Alignment Maintenance

After the UE is configured with its serving cell(s) for a given cell group (e.g. MCG and/or SCG), the UE obtains the initial TA value via a RAR message and is configured with the association between serving cells and TAG identifiers. The UE needs to maintain the time alignment according to the TA procedure defined in Clause 5.2 in 3GPP TS 38.321.

For the purpose of time alignment maintenance, a time alignment timer per TAG is used to control how long the MAC entity considers the Serving Cells belonging to the associated TAG to be uplink time aligned.

Upon reception of the Timing Advance Command (which is a MAC CE), the UE applies the time advance indicated in the command if the time alignment timer has not been expired and start/re-start the timer.

When the time alignment timer expires, the following procedure is specified in 3GPP TS 38.321 where a PTAG (primary TAG) is a TAG containing the SpCell of a MAC entity and a STAG (secondary TAG) is a TAG containing cells other than a primary cell.
if the time Alignment Timer is associated with the PTAG:
   flush all HARQ buffers for all Serving Cells;
   notify RRC to release PUCCH for all Serving Cells, if configured;
   notify RRC to release SRS for all Serving Cells, if configured;
   clear any configured downlink assignments and configured uplink grants;
   clear any PUSCH resource for semi-persistent CSI reporting;
   consider all running time Alignment Timers as expired;
   maintain N_{TA} of all TAGS.
else if the time Alignment Timer is associated with a STAG, then for all Serving Cells belonging to this TAG:
   flush all HARQ buffers;
   notify RRC to release PUCCH, if configured;
   notify RRC to release SRS, if configured;
   clear any configured downlink assignments and configured uplink grants;
   clear any PUSCH resource for semi-persistent CSI reporting;
   maintain N_{TA} of this TAG.

The MAC entity shall not perform any uplink transmission on a Serving Cell except the Random Access Preamble and MSGA transmission when the timeAlignmentTimer associated with the TAG to which this Serving Cell belongs is not running. Furthermore, when the timeAlignmentTimer associated with the PTAG is not running, the MAC entity shall not perform any uplink transmission on any Serving Cell except the Random Access Preamble and MSGA transmission on the SpCell.

Further details of the maintenance procedure can be found in 3GPP TS 38.321.

### 6 Release 18 Timing Advance Enhancements for Multi-DCI Based Multi-TRP

In NR Rel-18, two TAs, one for each TRP, is to be studied for multi-DCI based uplink transmissions towards two TRPs where a large time difference between the two TRPs may exist. For UL transmissions to different TRPs, different time advances are applied such that the received UL signals at each intended TRP are time aligned.

In RAN1 #110bis-e meeting in October 2022, the following agreement was made:
Agreement
Multi-DCI multi-TRP operation with two TAs is supported for Rel-15/16/17 TCI frameworks and unified TCI framework extension discussed in 9.1.1.1 as well as UL beam indication via spatial relation.

According to the above agreement, two TA enhancement for multi-DCI multi-TRP operation is to be enhanced for both Release 15/16 TCI framework and the unified TCI framework introduced in Release 17. The two TA enhancement for multi-DCI multi-TRP operation is also to be supported for spatial relation indication.

Solutions have been proposed on how to associate TAGs for multi-DCI based multi-TRP operation. The following solutions have been proposed:
Associating a TAG with a spatial relation such that each channel/signal that is configured with a certain spatial relation uses the associated TAG
Associating a TAG with an uplink or joint TCI state such that each channel/signal that is configured with an uplink or joint TCI state uses the associated TAG

### Summary

Systems and methods for associating uplink parameters to Transmission and Reception Points (TRPs) for multi-Downlink Control information (DCI) based multi-TRP operation are disclosed. In one embodiment, a method performed by a User Equipment (UE) comprises receiving a first DCI in a first Control Resource Set (CORESET) associated to a first CORESET pool index, wherein the first CORESET pool index is associated to a first time advanced group (TAG) identifier (ID), the first DCI either schedules transmission of a first Physical Uplink Shared Channel (PUSCH) or activates a configured grant for transmission of the first PUSCH, the UE is configured with a first Sounding Reference Signal (SRS) resource set that is associated to the first CORESET pool index, and an SRS Resource Indicator (SRI) field in the first DCI indicates an SRS resource in the first SRS resource set. The method further comprises receiving a second DCI in a second CORESET associated to a second CORESET pool index, wherein the second CORESET pool index is associated to a second TAG ID, the second DCI either schedules transmission of a second PUSCH or activates a configured grant for transmission of the second PUSCH, the UE is configured with a second SRS resource set that is associated to the second CORESET pool index, and an SRI field in the second DCI indicates an SRS resource in the second SRS resource set. The method further comprises transmitting the first PUSCH in accordance with the first DCI and the first TAG identifier and transmitting the second PUSCH in accordance with the second DCI and the second TAG identifier. In this manner, different timing advances may be applied to the different PUSCHs.

In one embodiment, the first CORESET pool index is 0, and the second CORESET pool index is 1. In one embodiment, the first SRS resource set has a smaller SRS resource set identifier than that of the second SRS resource set.

In one embodiment, the first SRS resource set associated to the first CORESET pool index is associated to the first TAG ID, and the second SRS resource set associated to the second CORESET pool index is associated to the second TAG ID.

In one embodiment, the method further comprises transmitting SRS resources in the first SRS resource set according to the first TAG ID and transmitting SRS resources in the second SRS resource set according to the second TAG ID.

In one embodiment, the method further comprises receiving a first and a second timing advance (TA) values associated to the first and the second TAG IDs, respectively.

In one embodiment, the transmitting according to the first or the second TAG ID comprises applying a time advance according to the first or the second TA value.

In one embodiment, the first SRS resource set associated to the first CORESET pool index is associated to a first Timing Advance Group, TAG, and the second SRS resource set associated to the second CORESET pool index is associated to a second TAG, wherein the first SRS resource set has a lower SRS resource set index than the second SRS resource set, and the first TAG is a TAG configured for the first CORESET pool index, the first CORESET pool index being 0.

Corresponding embodiment of a UE are also disclosed. In one embodiment, a UE is adapted to receive a first DCI in a first CORESET associated to a first CORESET pool index, wherein the first CORESET pool index is associated to a first TAG ID, the first DCI either schedules transmission of a first PUSCH or activates a configured grant for transmission of the first PUSCH, the UE is configured with a first SRS resource set that is associated to the first CORESET pool index, and an SRI field in the first DCI indicates an SRS resource in the first SRS resource set. The UE is further adapted to receive a second DCI in a second CORESET associated to a second CORESET pool index, wherein the second CORESET pool index is associated to a second TAG ID, the second DCI either schedules transmission of a second PUSCH or activates a configured grant for transmission of the second PUSCH, the UE is configured with a second SRS resource set that is associated to the second CORESET pool index, and an SRI field in the second DCI indicates an SRS resource in the second SRS resource set. The UE is further adapted to transmit the first PUSCH in accordance with the first DCI and the first TAG identifier and transmit the second PUSCH in accordance with the second DCI and the second TAG identifier.

In one embodiment, a UE comprises a communication interface comprising a transmitter and a receiver, and processing circuitry associated with the communication interface. The processing circuitry is configured to cause the UE to receive a first DCI in a first CORESET associated to a first CORESET pool index, wherein the first CORESET pool index is associated to a first TAG ID, the first DCI either schedules transmission of a first PUSCH or activates a configured grant for transmission of the first PUSCH, the UE is configured with a first SRS resource set that is associated to the first CORESET pool index, and an SRI field in the first DCI indicates an SRS resource in the first SRS resource set. The processing circuitry is further configured to cause the UE to receive a second DCI in a second CORESET associated to a second CORESET pool index, wherein the second CORESET pool index is associated to a second TAG ID, the second DCI either schedules transmission of a second PUSCH or activates a configured grant for transmission of the second PUSCH, the UE is configured with a second SRS resource set that is associated to the second CORESET pool index, and an SRI field in the second DCI indicates an SRS resource in the second SRS resource set. The processing circuitry is further configured to cause the UE to transmit the first PUSCH in accordance with the first DCI and the first TAG identifier and transmit the second PUSCH in accordance with the second DCI and the second TAG identifier.

Embodiments of a method performed by one or more network nodes are also disclosed. In one embodiment, a method performed by one or more network nodes comprises transmitting to a UE a first DCI in a first CORESET associated to a first CORESET pool index, wherein the first CORESET pool index is associated to a first TAG identifier, the first DCI either schedules transmission of a first PUSCH or activates a configured grant for transmission of the first PUSCH, the UE is configured with a first SRS resource set that is associated to the first CORESET pool index, and an SRI field in the first DCI indicates an SRS resource in the first SRS resource set. The method further comprises transmitting to the UE a second DCI in a second CORESET associated to a second CORESET pool index, wherein the second CORESET pool index is associated to a second TAG identifier, the second DCI either schedules transmission of a second PUSCH or activates a configured grant for transmission of the second PUSCH, the UE is configured with a second SRS resource set that is associated to the second CORESET pool index, and an SRI field in the second DCI indicates an SRS resource in the second SRS resource set.

Corresponding embodiments of the one or more network nodes are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the New Radio (NR) time-domain structure with 15 kilohertz (kHz) subcarrier spacing;

FIG. 2 illustrates the basic NR physical time-frequency resource grid;

FIGS. 3 and 4 illustrate examples of multi-Downlink Control Information (DCI) scheduling in NR Release 16;

FIG. 5 illustrates an example of time alignment and uplink synchronization in NR;

FIG. 6 illustrates a time advance command Medium Access Control (MAC) Control Element (CE);

FIG. 7 shows an example of uplink (UL) time alignment to two Transmission and Reception Points (TRPs) with two different timing advances, N_{TA1} and N_{TA2}, in accordance with embodiments of the present disclosure;

FIG. 8 illustrate an example of an embodiment of the present disclosure in which Control Resource Sets (CORESETs) #1 and #2 are configured with CORESET pool index 0 and are associated to TRP #1 while CORESETs #3 and #4 are configured with CORESET pool index 1 and are associated to TRP #2;

FIGS. 9A and 9B, 10, 11, 12, 13, and 14 illustrate example embodiments of the present disclosure;

FIG. 15 is a flow chart that illustrates the operation of a User Equipment (UE), in accordance with some embodiments of the present disclosure;

FIG. 16 is a flow chart that illustrates the operation of one or more network nodes, in accordance with some embodiments of the present disclosure;

FIG. 17 shows an example of a communication system, in accordance with some embodiments;

FIG. 18 shows a UE in accordance with some embodiments;

FIG. 19 shows a network node, in accordance with some embodiments;

FIG. 20 is a block diagram of a host, which may be an embodiment of the host of FIG. 17, in accordance with various aspects described herein;

FIG. 21 is a block diagram illustrating a virtualization environment in which functions implemented by some embodiments may be virtualized; and

FIG. 22 shows a communication diagram of a host communicating via a network node with a UE over a partially wireless connection in accordance with some embodiments.

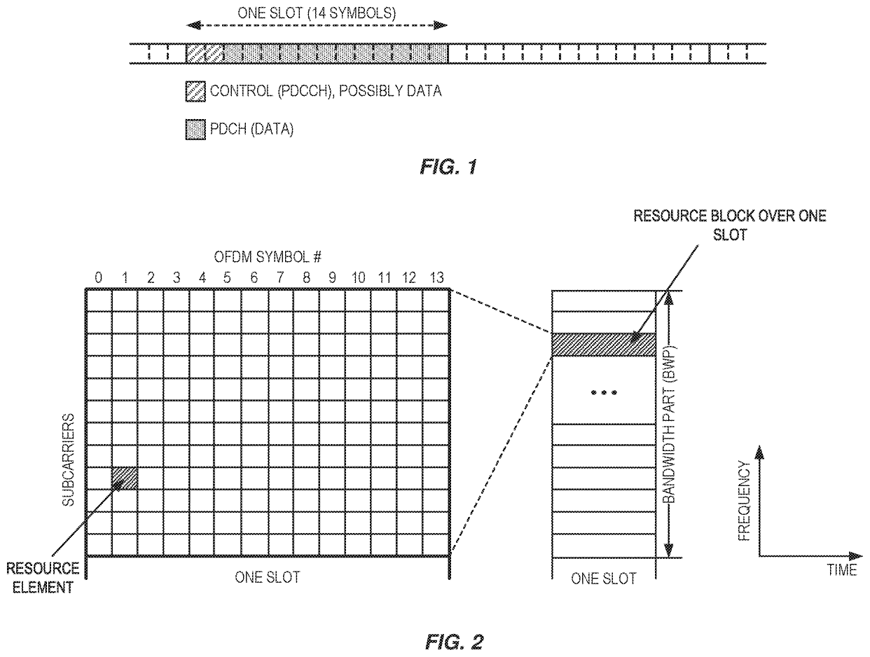

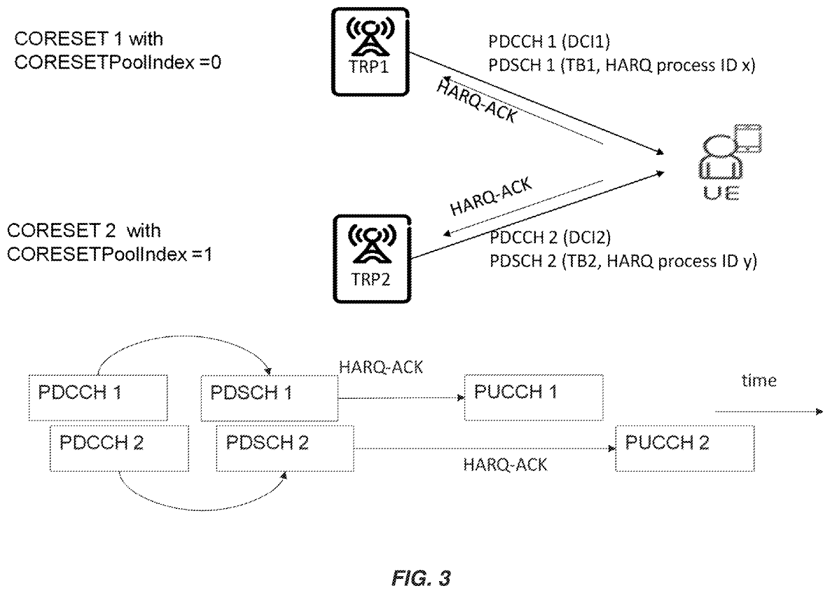

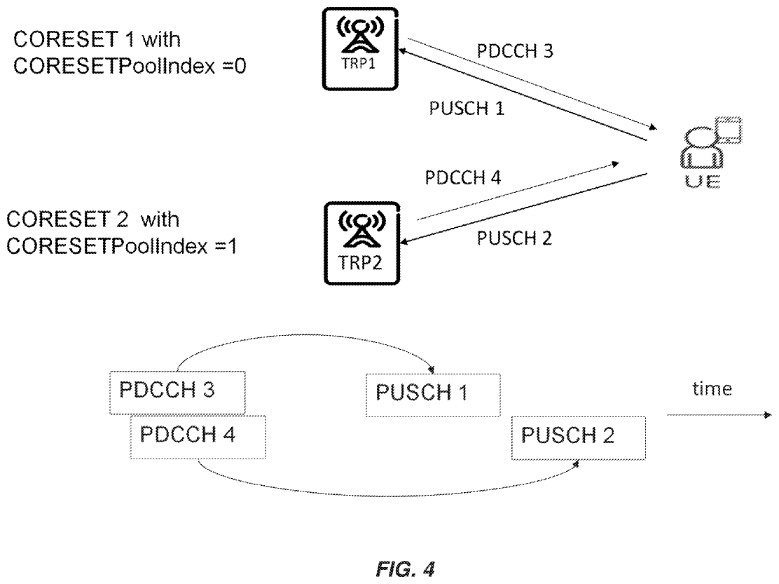

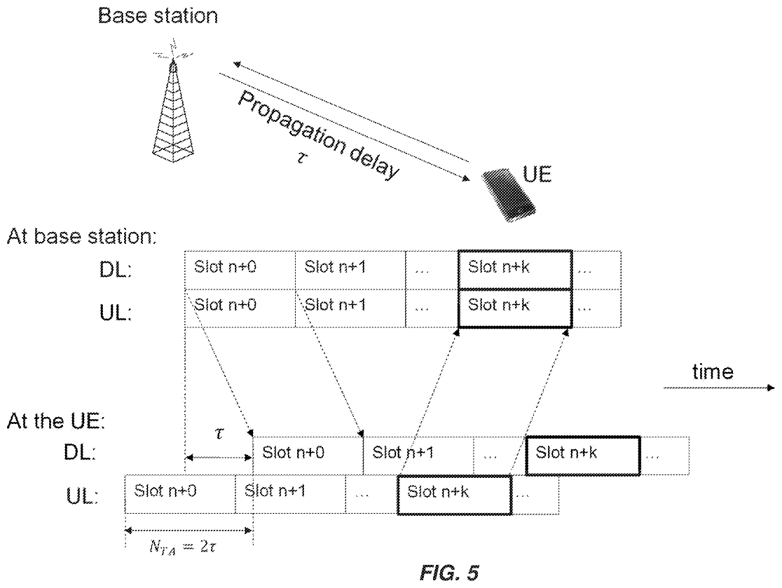

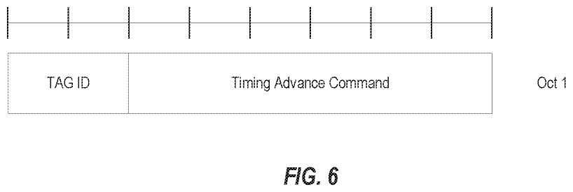

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

There currently exist certain challenge(s). The solution of associating a Timing Advance Group (TAG) with an uplink or joint Transmission Configuration Indicator (TCI) state has been adopted in 3^{rd} Generation Partnership Project (3GPP) for two Timing Advance (TA) enhancement for multi-Downlink Control Information (DCI) multi-Transmission and Reception Point (TRP) operation when the feature is used for User Equipments (UEs) that support multi-TRP extension of the unified TCI state framework introduced in New Radio (NR) Release 17.

How to support two TA enhancement for multi-DCI based multi-TRP operation for UEs that support the legacy Release 15/16 framework (i.e., the framework supported in NR Release 15/16) is still an open issue.

Associating a TAG with a spatial relation is one solution for supporting two TA enhancements for multi-DCI based multi-TRP operation. However, this solution only works for frequency range 2 (FR2) as NR UEs only support spatial relation signaling for FR2. For UEs that support the legacy Release 15/16 framework in frequency range 1 (FR1), the solution of associating a TAG with spatial relation does not work as spatial relation signaling is not supported in FR1. Hence, how to enhance two TA support for multi-DCI based multi-TRP operation for the legacy Release 15/16 framework in FR1 is an open problem to be solved.

Certain aspects of the disclosure and their embodiments may provide solutions to these or other challenges. Some example embodiments include one or more of the following:
Group uplink (UL) channels/signals into two groups where a first group corresponds to transmission towards a first TRP and the second group corresponds to transmission towards a second TRP,
   wherein each group is associated to a Control Resource Set (CORESET) Pool Index and two Sounding Reference Signal (SRS) resource sets with the same usage are associated with different CORESET Pool Indices,
   wherein each group is associated with a TAG index (i.e., TAG1) and the TAG index is associated with any one of the following:
      an SRS resource set (note that both explicitly configuring a TAG ID in a SRS resource set or implicitly associating a TAG ID to a SRS resource set are disclosed),
      an SRS Resource Indicator (SRI)-Physical Uplink Shared Channel (PUSCH)-PowerControl information element (note that both explicitly configuring a TAG ID in SRI-PUSCH-PowerControl element or implicitly associating a TAG ID to an SRI-PUSCH-PowerControl element are disclosed),
      a list of SRI-PUSCH-PowerControl information elements,
      a Physical Uplink Control Channel (PUCCH)-PowerControlSetInfo information element (note that we have covered both explicitly configuring a TAG ID in PUCCH-PowerControlSetInfo element or implicitly associating a TAG ID to an PUCCH-PowerControlSetInfo).

Certain embodiments may provide one or more of the following technical advantage(s). Embodiments of the present disclosure may enable different TAs to be applied to different UL channels/signals by grouping the UL channels/signals for UEs supporting Release 15/16 framework in FR1.

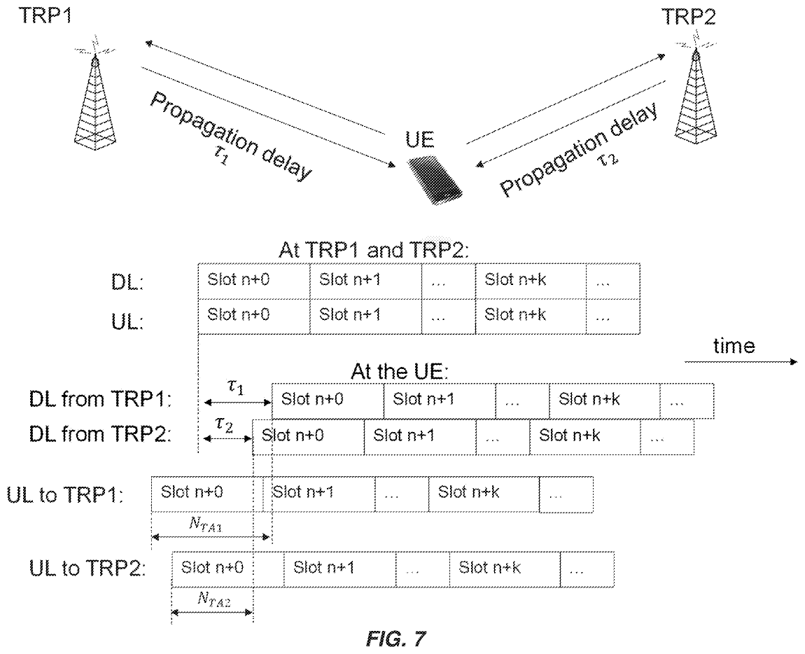

FIG. 7 shows an example of UL time alignment to two TRPs with two different timing advances, N_{TA1} and N_{TA2}. In FIG. 7, it is assumed that the downlink (DL) and UL slot/symbol timings are aligned at the two TRPs. Due to different propagation delays to the UE from the two TRPs, the received DL slot/symbol timings from the two TRPs at the UE are shifted in time. To achieve UL time alignment at each TRP, the UE needs to apply two different timing advances to its UL transmissions towards the two TRPs.

In FIG. 7, each of the two timing advances is with respect to the received DL timing from the respective TRP. Alternatively, both of the two time advances may be with respect to a common DL timing at the UE, e.g., either based on a received DL slot/symbol timing from TRP1 or TRP2.

It is envisioned that for UL transmission to two TRPs in a serving cell, two TAGs may be configured. For UL channels or signals transmitted towards each TRP, a TAG can be indicated. Different TAG values may be indicated for UL channels and signals to be transmitted to different TRPs.

When multi-DCI based UL transmissions to multiple TRPs are configured for a UE, two CORESET pool index values are configured. In one embodiment, two SRS resource sets are configured and each of the two SRS resource sets is associated to one of the two CORESET pool indices. For example, a first SRS resource set is associated to CORESET pool index=0 and a second SRS resource set is associated to CORESET pool index=1. In other words, for DCI format 0_1 or DCI format 0_2 received via a PDCCH carried in a CORESET configured with CORESET pool index=0, the SRI field in the DCI indicates an SRS resource in the first SRS resource set. For DCI format 0_1 or DCI format 0_2 received via a PDCCH carried in a CORESET configured with CORESET pool index=1, the SRI field in the DCI indicates an SRS resource in the second SRS resource set. The two SRS resource sets can be any one of the usages {beamManagement, codebook, nonCodebook, antennaSwitching}.

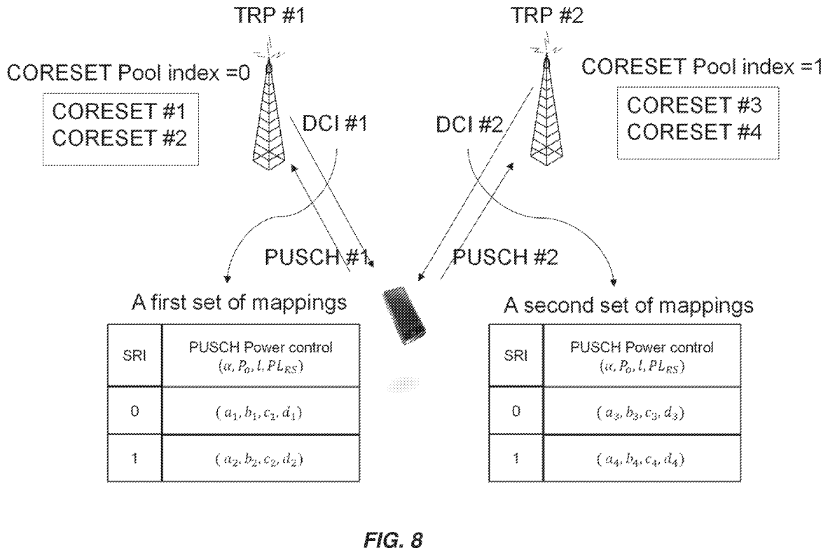

In some embodiments, for PUSCH transmissions, two sets of SRI to PUSCH power control parameter mappings are configured. A first set of mappings is for PUSCH transmissions scheduled by DCI received via a PDCCH in CORESETs configured with CORESET pool index=0 while a second set of mappings is for PUSCH transmissions scheduled by DCI received via a PDCCH in CORESETs configured with CORESET pool index=1. An example is shown in FIG. 8, where CORESETs #1 and #2 are configured with CORESET pool index 0 and are associated to TRP #1 while CORESETs #3 and #4 are configured with CORESET pool index 1 and are associated to TRP #2. For PUSCH #1 scheduled by DCI #1, the transmit power is calculated based on the first set of SRI to PUSCH power control parameters mappings, and for PUSCH #2 scheduled by DCI #2, the transmit power is calculated based on the second set of SRI to PUSCH power control parameters mappings. Note that in FIG. 8, (α, Pₒ, l, PL_{RS}) are the PUSCH power control parameters and (aᵢ, bᵢ, cᵢ, dᵢ) are the corresponding values or indices (e.g., IDs) that represent the corresponding values. Here, α, Pₒ, l, PL_{RS} are the parameters are defined as follows:
α is a fractional power control factor between 0 and 1 used to compensate for pathloss
P₀ is a received power target that is pre-configured
l is the closed loop index
PL_{RS} is the pathloss reference RS

In one embodiment, the first SRS resource set has a smaller SRS resource set index than that of the second SRS resource set.

### 1 TAG Association for PUSCHs Scheduled Via Multi-DCI Based Multi-TRPs

TAG association for PUSCH transmissions scheduled via multi-DCI based multi-TRP can be achieved in different ways which are covered in the embodiments below.

### 1.1 Associating TAG to SRI-PUSCH-PowerControl Elements

In 3GPP TS 38.331 V17.3.0, one or two lists of SRI-PUSCH-PowerControl elements can be configured as part of PUSCH-PowerControl information element (IE). When two lists of SRI-PUSCH-PowerControl elements (e.g., sri-PUSCH-MappingToAddModList and sri-PUSCH-MappingToAddModList2-r17 as defined in 3GPP TS 38.331) are configured as part of PUSCH-PowerControl IE, the first list of SRI-PUSCH-PowerControl elements (e.g., sri-PUSCH-MappingToAddModList) corresponds to PUSCH transmissions corresponding to a first SRS resource set, and the second list of SRI-PUSCH-PowerControl elements (e.g., sri-PUSCH-MappingToAddModList2-r17) corresponds to PUSCH transmissions corresponding to a second SRS resource set. The first and the second SRS resource sets are configured with usage ‘codebook’ or ‘noncodebook’ based PUSCH transmissions (i.e., the SRS resource sets are to be used for the purpose of either codebook based PUSCH transmission or non-codebook based PUSCH transmission).

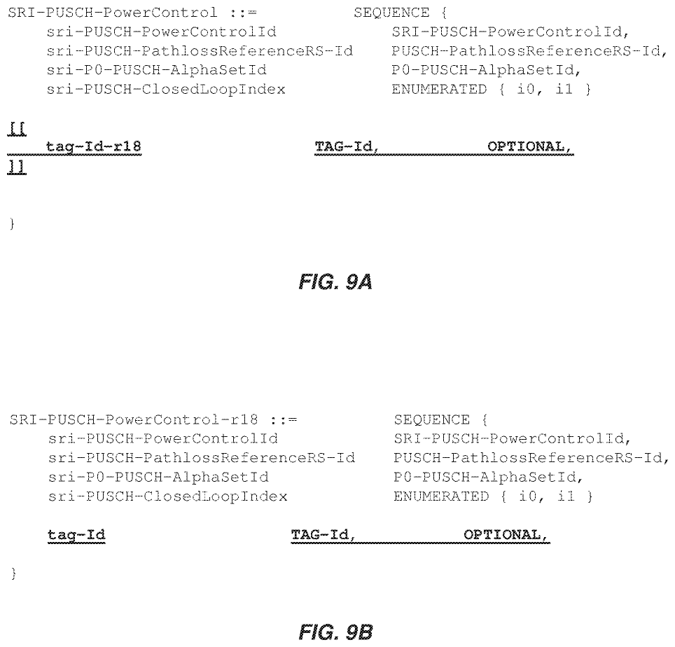

In one embodiment, a TAG ID is explicitly configured in each SRI-PUSCH-PowerControl element as shown by the example in FIG. 9A, where a “tag-id” is included in the SRI-PUSCH-PowerControl elements to indicate the associated TAG and corresponding TA. In an alternative embodiment, the example shown in FIG. 9A can be used for the case when one SRS resource set is configured for PUSCH transmission (i.e., either for ‘codebook’ or ‘non-codebook’ usage). In the alternative embodiment, which SRI-Power-Control element to use for PUSCH is indicated by the SRI field in DCI received via a PDCCH that is received in a CORESET that belongs to either first CORESET Pool Index or second CORESET Pool Index.

In another embodiment, a new RRC IE is introduced as shown in the example of FIG. 9B.

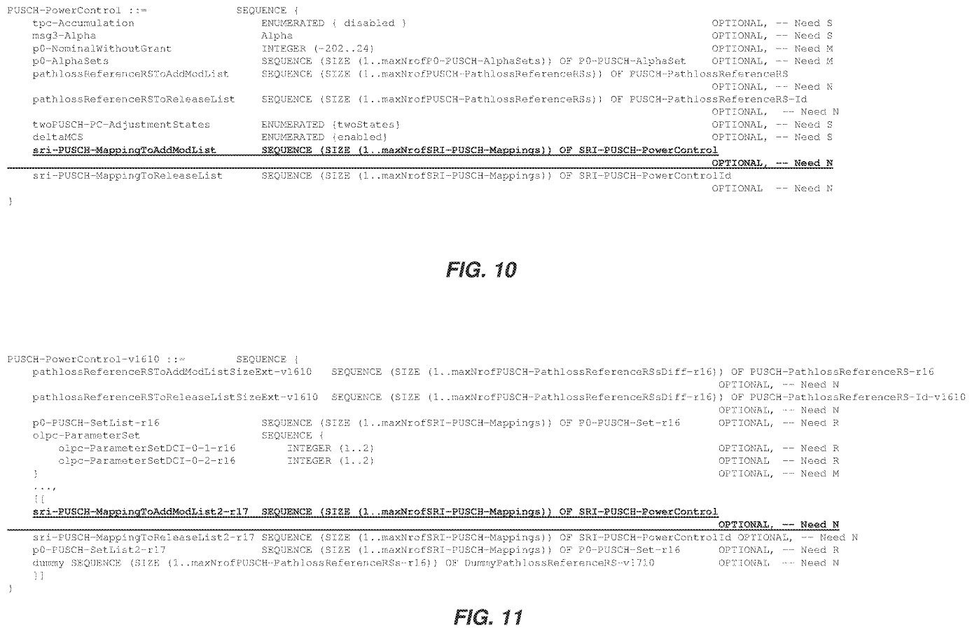

In another embodiment, the SRI-PUSCH-PowerControl elements configured as part of a first list are associated with a first “tag-id”. The SRI-PUSCH-PowerControl elements configured as part of a second list are associated with a second “tag-id”. In a first example:
the SRI-PUSCH-PowerControl elements in the list sri-PUSCH-MappingToAddModList shown in FIG. 10, are associated to the CORESET Pool Index 0 and are assumed to be associated with the first “tag-id”; and
the SRI-PUSCH-PowerControl elements in the list sri-PUSCH-MappingToAddModList2-r17 shown in FIG. 11, are associated to the CORESET Pool Index 1 and are assumed to be associated with the second “tag-id”.

In one variant of this embodiment, only one of the SRI-PUSCH-PowerControl elements in the first list (e.g., sri-PUSCH-MappingToAddModList) is configured with a first “tag-id” and the all the other SRI-PUSCH-PowerControl elements in the first list are implicitly associated with the same first “tag-id”. Likewise, only one of the SRI-PUSCH-PowerControl elements in the second list (e.g., sri-PUSCH-MappingToAddModList2-r17) is configured with a second “tag-id” and the all the other SRI-PUSCH-PowerControl elements in the second list are implicitly associated with the same second “tag-id”.

In another embodiment, a TAG ID may not be explicitly configured in each SRI-PUSCH-PowerControl. Instead, the first list (e.g., sri-PUSCH-MappingToAddModList) of SRI-PUSCH-PowerControl elements associated to a first CORESET Pool Index is implicitly associated with the same first “tag-id”. The second list (e.g., sri-PUSCH-MappingToAddModList2-r17) of SRI-PUSCH-PowerControl elements associated to a second CORESET Pool Index is implicitly associated with the same second “tag-id”.

In another embodiment, in the field description of the first list (e.g., sri-PUSCH-MappingToAddModList) of SRI-PUSCH-PowerControl elements in 3GPP TS 38.331, it is defined that the elements in this list are associated to a first CORESET Pool Index. Alternatively, it is defined that all elements are associated with the first “tag-id”. Yet in another alternative, in this field description, or elsewhere in 3GPP TS 38.331 it is specified that TAG id and CORESET Pool Index are used to identify association to TRP 1. Similar definitions apply for the second list (e.g., sri-PUSCH-MappingToAddModList2-r17) of SRI-PUSCH-PowerControl and association to a second CORESET Pool Index or second “tag-id”.

In another embodiment, ‘tag-Id’ is optionally configured in the SRI-PUSCH-PowerControl elements configured as part of a first list. In this embodiment, a first ‘tag-Id’ is provided by the ‘tag-Id’ configured in the ServingCellConfig of the serving cell in which PUSCH is transmitted, where the first ‘tag-Id’ is associated with the first list of SRI-PUSCH-PowerControl elements. Only the second TAG with a second ‘tag-Id’ is conjured in the SRI-PUSCH-PowerControl elements configured as part of a first list.

For PUSCH scheduled by a PDCCH carrying a DCI received in a CORESET belonging a first CORESET Pool Index, the UE applies the timing advance corresponding to the TAG associated with the first list of SRI-PUSCH-PowerControl elements (note that the TAG corresponding to the first list of SRI-PUSCH-PowerControl elements is associated with the first CORESET Pool Index according to the above embodiments). For PUSCH scheduled by a PDCCH carrying a DCI received in a CORESET belonging a second CORESET Pool Index, the UE applies the timing advance corresponding to the TAG associated with the second list of SRI-PUSCH-PowerControl elements.

For PUSCH with type 2 configured grant and activated by a PDCCH carrying a DCI received in a CORESET associated to a first CORESET Pool Index, the UE applies the timing advance corresponding to the TAG associated with the first list of SRI-PUSCH-PowerControl elements (note that the TAG corresponding to the first list of SRI-PUSCH-PowerControl elements is associated with the first CORESET Pool Index according to the above embodiments). For PUSCH with type 2 configured grant and activated by a PDCCH carrying a DCI received in a CORESET associated to a second CORESET Pool Index, the UE applies the timing advance corresponding to the TAG associated with the second list of SRI-PUSCH-PowerControl elements.

### 1.2 Associating TAG to SRS Resource Sets

In NR, two SRS resource sets can be configured with usage ‘codebook’ or ‘noncodebook’ based PUSCH transmission for multi DCI based multi-TRP PUSCH transmission (i.e., a single DCI schedules the PUSCH transmissions towards different TRPs).

In one embodiment, for either one of the ‘codebook’ or ‘non-codebook’ based PUSCH usages, the first SRS resource set corresponds to a first CORESET pool Index and the second SRS resource set corresponds to a second CORESET pool Index.

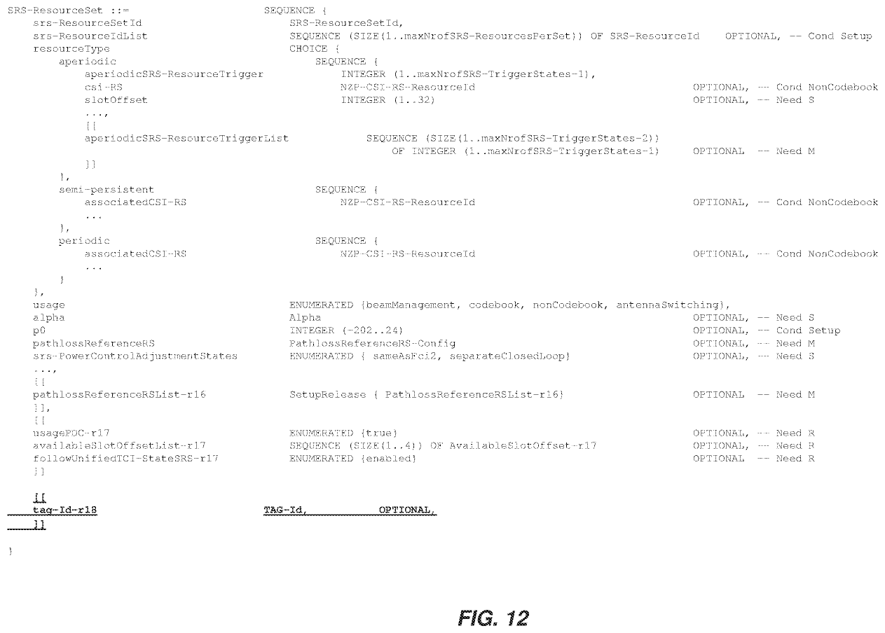

In one embodiment, a TAG ID is explicitly configured in each SRS Resource set as shown by the example in FIG. 12, where a “tag-id” is included in the SRS Resource Set to indicate the associated TAG and corresponding TA.

In another embodiment, a TAG ID may not be explicitly configured in each SRS Resource Set. Instead, the first SRS Resource Set associated to a first CORESET Pool Index is implicitly associated with a first “tag-id”. The second SRS Resource Set associated to a second CORESET Pool Index is implicitly associated with a second “tag-id”.

In another embodiment, ‘tag-Id’ is optionally configured in the SRS Resource set. In this embodiment, a first ‘tag-Id’ is provided by the ‘tag-Id’ configured in the ServingCellConfig of the serving cell in which PUSCH is transmitted, where the first ‘tag-Id’ is associated with the first SRS Resource Set. Only the second TAG with a second ‘tag-Id’ is configured in the second SRS Resource Set.

For PUSCH scheduled by a PDCCH carrying a DCI received in a CORESET belonging a first CORESET Pool Index, the UE applies the timing advance corresponding to the TAG associated with the first SRS Resource Set (note that the TAG corresponding to the first SRS Resource Set is associated with the first CORESET Pool Index according to the above embodiments). For PUSCH scheduled by a PDCCH carrying a DCI received in a CORESET belonging a second CORESET Pool Index, the UE applies the timing advance corresponding to the TAG associated with the second SRS Resource Set.

For PUSCH with type 2 configured grant and activated by a PDCCH carrying a DCI received in a CORESET associated to a first CORESET Pool Index, the UE applies the timing advance corresponding to the TAG associated with the first SRS Resource Set. For PUSCH with type 2 configured grant and activated by a PDCCH carrying a DCI received in a CORESET associated to a second CORESET Pool Index, the UE applies the timing advance corresponding to the TAG associated with the second SRS Resource Set.

In another embodiment, a TAG ID or information for the TAG ID (e.g., a first or second TAG ID) is configured in each SRS resource. A TA associated to a TAG or TAG ID configured for an SRS resource is applied to PUSCH transmissions associated to the SRS resource.

For a type 1 configured grant (CG) based PUSCH, a TAG associated to a SRS resource that is indicated by a higher layer parameter “srs-ResourceIndicator” configured for the type 1 CG PUSCH is applied to the PUSCH.

### 1.3 TAG Association for PUCCH Transmission

In NR, multiple PUCCH-PowerControlSetInfo elements can be configured in a list as part of PUCCH-PowerControl IE in 3GPP TS 38.331. Each PUCCH resource can be activated with one or two PUCCH-PowerControlSetInfo's.

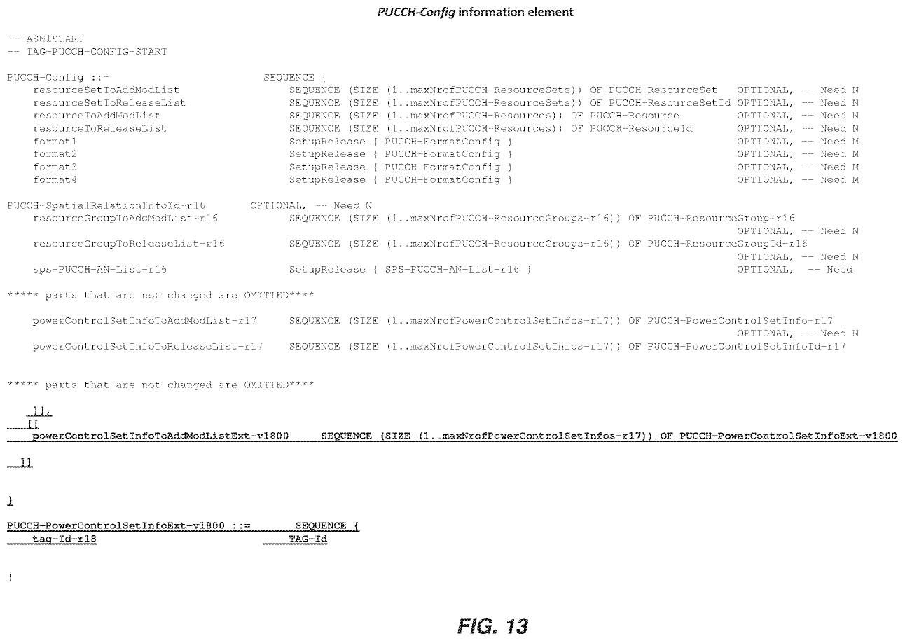

In one embodiment, a TAG ID is explicitly configured in each PUCCH-PowerControlSetInfo as shown by the example in FIG. 13, where a “tag-id” is included in the PUCCH-PowerControlSetInfo to indicate the associated TAG and corresponding TA.

### 1.3.1 PUCCH-Config

The IE PUCCH-Config is used to configure UE specific PUCCH parameters (per BWP). FIG. 13 illustrates an example of the PUCCH-Config IE having an explicitly configured tag-Id per PUCCH-PowerControlSetInfo.

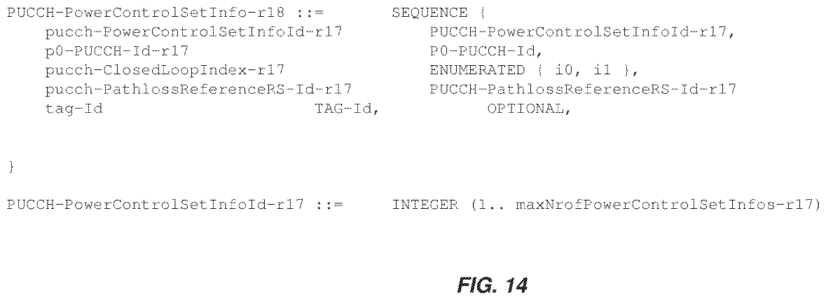

In an alternative embodiment, a new IE is introduced in order to configure tag-Id per PUCCH-PowerControlSetInfo as shown in the example of FIG. 14.

In another embodiment, ‘tag-Id’ is optionally configured in the PUCCH-PowerControlSetInfo. In this embodiment, a first ‘tag-Id’ is provided by the ‘tag-Id’ configured in the ServingCellConfig of the serving cell in which PUCCH is transmitted, where the first ‘tag-Id’ is associated with a first subset of PUCCH-PowerControlSetInfo elements that do not have a ‘tag-Id’ configured explicitly. A second TAG with a second ‘tag-Id’ is explicitly configured in a second subset of PUCCH-PowerControlSetInfo elements.

For PUCCH transmissions in a given PUCCH resource, the UE applies the timing advance corresponding to the TAG associated with the PUCCH-PowerControlSetInfo that is activated for that PUCCH resource.

In another embodiment, a TAG ID or information about the TAG ID associated to a PUCCH resource may be configured in the PUCCH resource. When PUCCH resource groups are configured, all PUCCH resource in a PUCCH resource group share a same TAG (or TAG ID) and thus, only one PUCCH resource in the PUCCH resource group needs to be configured with the TAG ID. Alternatively, a TAG ID for a PUCCH resource or a PUCCH resource group may be activated by a MAC CE, where the MAC CE includes at least the TAG ID and the PUCCH resource index.

### 1.4 TAG Association for SRS Transmission

When a single SRS resource set with usage set to either “codebook” or “nonCodebook” is configured for multi-DCI based multi-TRP operation (i.e., with two CORESET pool index values) and two TAGs are configured in a serving cell, each SRS resource in the SRS resource set can be associated to one of the two TAGs. The association may be explicitly configured by including information of the associated TAG in each SRS resource.

When two SRS resource sets with usage set to either “codebook” or “nonCodebook” are configured for multi-DCI multi-TRP and two TAGs are configured in a serving cell, each of the two SRS resource sets is associated to one of the two TAGs. The association may be explicitly configured by including information of the associated TAG in each SRS resource set. Alternatively, a first SRS resource set is associated to a first TAG and the second SRS resource set is associated to a second TAG, where the first SRS resource set is the one having a lower SRS resource set index among the two SRS resource sets and the first TAG may be according to the order of the two TAGs configured or is a TAG configured for CORESET pool index=0.

These embodiments are non-limiting and are applicable to SRS resource sets configured with any one of the usages {beamManagement, codebook, nonCodebook, antennaSwitching}.

### 1.5 Additional Embodiments for Configuration TAG IDs

In one embodiment, the second TAG id needs to have the same value for all UL channels and RSs in one serving cell where it is applied. For example, if second SRI-PUSCH power control list has TAG ID value 2 or TAG ID value 4, also the second SRS resource set and the second PUCCH powercontrollistInfo needs to have the same value, whether it is 2 or 4 for that serving cell. It follows that all UL elements configured with the same TAG ID follow the same UL timing. If the same TAG ID is also configured in UL channels for other serving cells, those follow also the same UL timing.

In one embodiment, in servingCellConfig, where the original TAG ID (e.g., the first TAG ID) is given, the additional TAG ID (e.g., the second TAG ID) is also given. This additionalTAG ID may be using the existing TAG ID IE defined in TS 38.331 or a new definition. Or two new tag IDs are given which are then used for the corresponding uplink transmissions.

Although TAG ID is discussed above, the same approach may also be used to configuring other TRP specific parameters for PUSCH, PUCCH, or SRS transmissions to a TRP.

### 2 Further Description

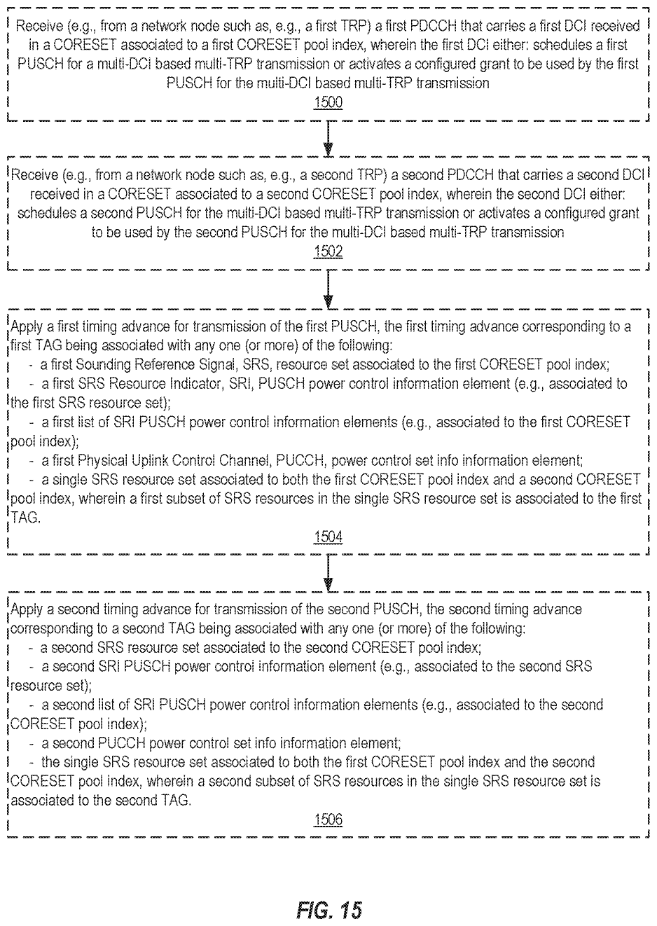

FIG. 15 is a flow chart that illustrates the operation of a UE for multi-DCI based multi-TRP uplink transmission in accordance with at least some of the embodiments described above (e.g., in Section 1 of the Additional Explanation section). Optional steps are represented by dashed boxes. As illustrated, the UE optionally receives (e.g., from a network node such as, e.g., a first TRP), a first PDCCH that carries a first DCI received in a CORESET associated to a first CORESET pool index (step 1500). The first DCI either: (a) schedules a first PUSCH for a multi-DCI based multi-TRP transmission or (b) activates a configured grant (e.g., type 2 CG) to be used by the first PUSCH for the multi-DCI based multi-TRP transmission. The UE may also optionally receive (e.g., from a network node such as, e.g., a second TRP) a second PDCCH that carries a second DCI received in a CORESET associated to the second CORESET pool index (step 1502). The second DCI either: (a) schedules a second PUSCH for the multi-DCI based multi-TRP transmission or (b) activates a configured grant to be used by the second PUSCH for the multi-DCI based multi-TRP transmission.

The UE optionally applies a first timing advance for transmission of the first PUSCH for the multi-DCI based multi-TRP PUSCH transmission (step 1504). As discussed above, the first timing advance corresponds to a first TAG being associated with any one (or more) of the following:
the first Sounding Reference Signal, SRS, resource set associated to the first CORESET pool index;
a first SRS Resource Indicator, SRI, PUSCH power control information element (e.g., associated to the first SRS resource set);
a first list of SRI PUSCH power control information elements (e.g., associated to the first CORESET pool index);
a first Physical Uplink Control Channel, PUCCH, power control set info information element;
a single SRS resource set associated to both the first CORESET pool index and a second CORESET pool index, wherein a first subset of SRS resources in the single SRS resource set is associated to the first TAG.
   The UE may also optionally apply a second timing advance for transmission of the second PUSCH for the multi-DCI based multi-TRP PUSCH transmission (step 1506). The second timing advance corresponding to a second TAG being associated with any one (or more) of the following:
the second SRS resource set associated to the second CORESET pool index;
a second SRS Resource Indicator, SRI, PUSCH power control information element (e.g., associated to the second SRS resource set);
a second list of SRI PUSCH power control information elements (e.g., associated to the second CORESET pool index);
a second PUCCH power control set info information element;
the single SRS resource set associated to both the first CORESET pool index and the second CORESET pool index, wherein a second subset of SRS resources in the single SRS resource set is associated to the second TAG, and the first subset of SRS resources and the second subset of SRS resources are different (e.g., non-overlapping) subsets of the single SRS resource set.

In one embodiment, the first TAG is associated with the first SRS resource set associated to the first CORESET pool index and the second TAG is associated with the second SRS resource set associated to the second CORESET pool index. In one embodiment, a first TAG Identifier, ID, of the first TAG is explicitly configured in the first SRS resource set, and a second TAG ID of the second TAG is explicitly configured in the second SRS resource set. In another embodiment, the first SRS resource set associated to the first CORESET pool index is implicitly associated to a first TAG Identifier, ID, of the first TAG, and the second SRS resource set associated to the second CORESET pool index is implicitly associated to a second TAG ID of the second TAG. In another embodiment, a first TAG Identifier, ID, of the first TAG is configured in a serving cell configuration of a serving cell in which the first PUSCH is transmitted. In one embodiment, the first TAG ID is associated with the first SRS resource set. In one embodiment, a second TAG ID of the second TAG is configured in the second SRS resource set. In another embodiment, a first TAG Identifier, ID, of the first TAG is configured in each SRS resource in the first SRS resource set, and a second TAG ID of the second TAG is configured in each SRS resource in the second SRS resource set. In another embodiment, the first DCI activates a type 1 configured grant to be used by the first PUSCH for the multi-DCI based multi-TRP transmission, and a first TAG Identifier, ID, of the first TAG is associated to an SRS resource in the first SRS resource set that is indicated by higher layer parameter “srs-ResourceIndicator” configured for type 1 CG PUSCH.

In another embodiment, the first TAG is configured in the first SRI PUSCH power control information element, and the second TAG is configured in the second SRI PUSCH power control information element.

In another embodiment, the first TAG is configured in the first SRI PUSCH power control information element, and the first SRI PUSCH power control information element is associated to the first SRS resource set that is associated to the first CORESET pool index, and the second TAG is configured in the second SRI PUSCH power control information element, and the second SRI PUSCH power control information element is associated to the second SRS resource set that is associated to the second CORESET pool index.

In another embodiment, a first TAG ID of the first TAG is associated with a first list of SRI PUSCH power control elements, and a second TAG ID of the second TAG is associated with a second list of SRI PUSCH power control elements. In one embodiment, the first list of SRI PUSCH power control elements is associated to the first CORESET pool index (e.g., in a field description of the first list), and the second list of SRI PUSCH power control elements is associated to the second CORESET pool index (e.g., in a field description of the first list). In one embodiment, only one SRI PUSCH power control element in the first list is explicitly configured with the first TAG ID, and only one of SRI PUSCH power control element in the second list is explicitly configured with the second TAG ID.

In another embodiment, a first TAG ID of the first TAG is implicitly associated with a first list of SRI PUSCH power control elements which is associated to the first CORESET pool index, and a second TAG ID of the second TAG is implicitly associated with a second list of SRI PUSCH power control elements which is associated to the second CORESET pool index.

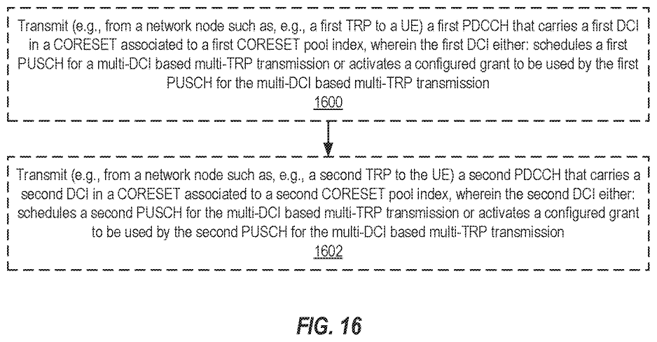

FIG. 16 is a flow chart that illustrates the operation of one or more network nodes (e.g., a first TRP and a second TRP) to enable multi-DCI based multi-TRP uplink transmission in accordance with at least some of the embodiments described above (e.g., in Section 1 of the Additional Explanation section). Optional steps are represented by dashed boxes. As illustrated, a network node (e.g., a first TRP) optionally transmits, to a UE, a first PDCCH that carries a first DCI received in a CORESET associated to a first CORESET pool index (step 1600). The first DCI either: (a) schedules a first PUSCH for a multi-DCI based multi-TRP transmission or (b) activates a configured grant (e.g., type 2 CG) to be used by the first PUSCH for the multi-DCI based multi-TRP transmission. A network node (e.g., a second TRP) may also optionally transmit, to the UE, a second PDCCH that carries a second DCI received in a CORESET associated to the second CORESET pool index (step 1602). The second DCI either: (a) schedules a second PUSCH for the multi-DCI based multi-TRP transmission or (b) activates a configured grant to be used by the second PUSCH for the multi-DCI based multi-TRP transmission.

A first timing advance to be applied by the UE for transmission of the first PUSCH for the multi-DCI based multi-TRP PUSCH transmission corresponds to a first TAG associated with any one (or more) of the following:
the first Sounding Reference Signal, SRS, resource set associated to the first CORESET pool index;
a first SRS Resource Indicator, SRI, PUSCH power control information element (e.g., associated to the first SRS resource set);
a first list of SRI PUSCH power control information elements (e.g., associated to the first CORESET pool index);
a first Physical Uplink Control Channel, PUCCH, power control set info information element;
a single SRS resource set associated to both the first CORESET pool index and a second CORESET pool index, wherein a first subset of SRS resources in the single SRS resource set is associated to the first TAG.
   A second timing advance to be applied by the UE for transmission of the second PUSCH for the multi-DCI based multi-TRP PUSCH transmission corresponds to a second TAG associated with any one (or more) of the following:
the second SRS resource set associated to the second CORESET pool index;
a second SRS Resource Indicator, SRI, PUSCH power control information element (e.g., associated to the second SRS resource set);
a second list of SRI PUSCH power control information elements (e.g., associated to the second CORESET pool index);
a second PUCCH power control set info information element;
the single SRS resource set associated to both the first CORESET pool index and the second CORESET pool index, wherein a second subset of SRS resources in the single SRS resource set is associated to the second TAG, and the first subset of SRS resources and the second subset of SRS resources are different (e.g., non-overlapping) subsets of the single SRS resource set.

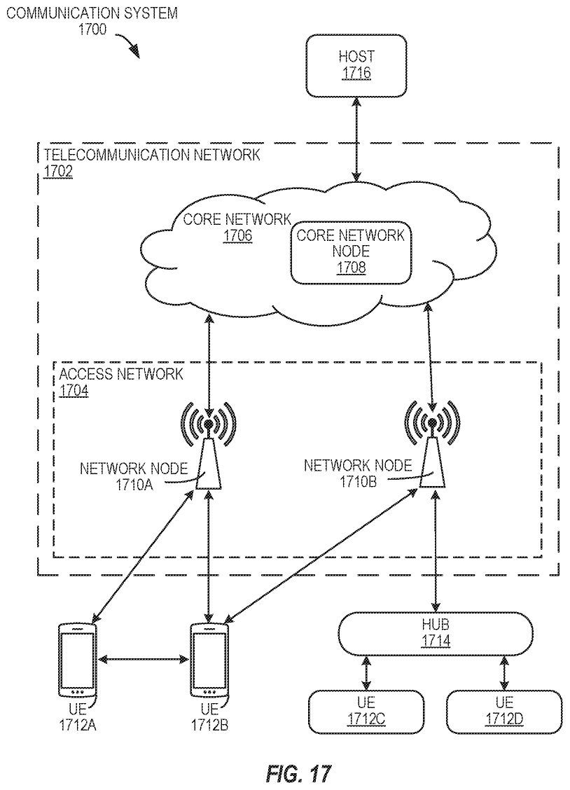

FIG. 17 shows an example of a communication system 1700 in accordance with some embodiments.

In the example, the communication system 1700 includes a telecommunication network 1702 that includes an access network 1704, such as a Radio Access Network (RAN), and a core network 1706, which includes one or more core network nodes 1708. The access network 1704 includes one or more access network nodes, such as network nodes 1710A and 1710B (one or more of which may be generally referred to as network nodes 1710), or any other similar Third Generation Partnership Project (3GPP) access nodes or non-3GPP Access Points (APs). Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1702 includes one or more Open-RAN (ORAN) network nodes. An ORAN network node is a node in the telecommunication network 1702 that supports an ORAN specification (e.g., a specification published by the O-RAN Alliance, or any similar organization) and may operate alone or together with other nodes to implement one or more functionalities of any node in the telecommunication network 1702, including one or more network nodes 1710 and/or core network nodes 1708.

Examples of an ORAN network node include an Open Radio Unit (O-RU), an Open Distributed Unit (O-DU), an Open Central Unit (O-CU), including an O-CU Control Plane (O-CU-CP) or an O-CU User Plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 1710 facilitate direct or indirect connection of User Equipment (UE), such as by connecting UEs 1712A, 1712B, 1712C, and 1712D (one or more of which may be generally referred to as UEs 1712) to the core network 1706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1700 may include any number of wired or wireless networks, network nodes, UEs, and/or any other components or systems that may facilitate or participate in the communication of data and/or signals whether via wired or wireless connections. The communication system 1700 may include and/or interface with any type of communication, telecommunication, data, cellular, radio network, and/or other similar type of system.

The UEs 1712 may be any of a wide variety of communication devices, including wireless devices arranged, configured, and/or operable to communicate wirelessly with the network nodes 1710 and other communication devices. Similarly, the network nodes 1710 are arranged, capable, configured, and/or operable to communicate directly or indirectly with the UEs 1712 and/or with other network nodes or equipment in the telecommunication network 1702 to enable and/or provide network access, such as wireless network access, and/or to perform other functions, such as administration in the telecommunication network 1702.

In the depicted example, the core network 1706 connects the network nodes 1710 to one or more hosts, such as host 1716. These connections may be direct or indirect via one or more intermediary networks or devices. In other examples, network nodes may be directly coupled to hosts. The core network 1706 includes one more core network nodes (e.g., core network node 1708) that are structured with hardware and software components. Features of these components may be substantially similar to those described with respect to the UEs, network nodes, and/or hosts, such that the descriptions thereof are generally applicable to the corresponding components of the core network node 1708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1716 may be under the ownership or control of a service provider other than an operator or provider of the access network 1704 and/or the telecommunication network 1702, and may be operated by the service provider or on behalf of the service provider. The host 1716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1700 of FIG. 17 enables connectivity between the UEs, network nodes, and hosts. In that sense, the communication system 1700 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1702 is a cellular network that implements 3GPP standardized features. Accordingly, the telecommunication network 1702 may support network slicing to provide different logical networks to different devices that are connected to the telecommunication network 1702. For example, the telecommunication network 1702 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1712 are configured to transmit and/or receive information without direct human interaction. For instance, a UE may be designed to transmit information to the access network 1704 on a predetermined schedule, when triggered by an internal or external event, or in response to requests from the access network 1704. Additionally, a UE may be configured for operating in single- or multi-Radio Access Technology (RAT) or multi-standard mode. For example, a UE may operate with any one or combination of WiFi, New Radio (NR), and LTE, i.e. being configured for Multi-Radio Dual Connectivity (MR-DC), such as Evolved UMTS Terrestrial RAN (E-UTRAN) NR-Dual Connectivity (EN-DC).

In the example, a hub 1714 communicates with the access network 1704 to facilitate indirect communication between one or more UEs (e.g., UE 1712C and/or 1712D) and network nodes (e.g., network node 1710B). In some examples, the hub 1714 may be a controller, router, content source and analytics, or any of the other communication devices described herein regarding UEs. For example, the hub 1714 may be a broadband router enabling access to the core network 1706 for the UEs. As another example, the hub 1714 may be a controller that sends commands or instructions to one or more actuators in the UEs. Commands or instructions may be received from the UEs, network nodes 1710, or by executable code, script, process, or other instructions in the hub 1714. As another example, the hub 1714 may be a data collector that acts as temporary storage for UE data and, in some embodiments, may perform analysis or other processing of the data. As another example, the hub 1714 may be a content source. For example, for a UE that is a Virtual Reality (VR) headset, display, loudspeaker or other media delivery device, the hub 1714 may retrieve VR assets, video, audio, or other media or data related to sensory information via a network node, which the hub 1714 then provides to the UE either directly, after performing local processing, and/or after adding additional local content. In still another example, the hub 1714 acts as a proxy server or orchestrator for the UEs, in particular if one or more of the UEs are low energy IoT devices.

The hub 1714 may have a constant/persistent or intermittent connection to the network node 1710B. The hub 1714 may also allow for a different communication scheme and/or schedule between the hub 1714 and UEs (e.g., UE 1712C and/or 1712D), and between the hub 1714 and the core network 1706. In other examples, the hub 1714 is connected to the core network 1706 and/or one or more UEs via a wired connection. Moreover, the hub 1714 may be configured to connect to a Machine-to-Machine (M2M) service provider over the access network 1704 and/or to another UE over a direct connection. In some scenarios, UEs may establish a wireless connection with the network nodes 1710 while still connected via the hub 1714 via a wired or wireless connection. In some embodiments, the hub 1714 may be a dedicated hub—that is, a hub whose primary function is to route communications to/from the UEs from/to the network node 1710B. In other embodiments, the hub 1714 may be a non-dedicated hub—that is, a device which is capable of operating to route communications between the UEs and the network node 1710B, but which is additionally capable of operating as a communication start and/or end point for certain data channels.

FIG. 18 shows a UE 1800 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle, vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1800 includes processing circuitry 1802 that is operatively coupled via a bus 1804 to an input/output interface 1806, a power source 1808, memory 1810, a communication interface 1812, and/or any other component, or any combination thereof. Certain UEs may utilize all or a subset of the components shown in FIG. 18. The level of integration between the components may vary from one UE to another UE. Further, certain UEs may contain multiple instances of a component, such as multiple processors, memories, transceivers, transmitters, receivers, etc.

The processing circuitry 1802 is configured to process instructions and data and may be configured to implement any sequential state machine operative to execute instructions stored as machine-readable computer programs in the memory 1810. The processing circuitry 1802 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1802 may include multiple Central Processing Units (CPUs).

In the example, the input/output interface 1806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1808 is structured as a battery or battery pack. Other types of power sources, such as an external power source (e.g., an electricity outlet), photovoltaic device, or power cell, may be used. The power source 1808 may further include power circuitry for delivering power from the power source 1808 itself, and/or an external power source, to the various parts of the UE 1800 via input circuitry or an interface such as an electrical power cable. Delivering power may be, for example, for charging of the power source 1808. Power circuitry may perform any formatting, converting, or other modification to the power from the power source 1808 to make the power suitable for the respective components of the UE 1800 to which power is supplied.

The memory 1810 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1810 includes one or more application programs 1814, such as an operating system, web browser application, a widget, gadget engine, or other application, and corresponding data 1816. The memory 1810 may store, for use by the UE 1800, any of a variety of various operating systems or combinations of operating systems.

The memory 1810 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1810 may allow the UE 1800 to access instructions, application programs, and the like stored on transitory or non-transitory memory media, to off-load data, or to upload data. An article of manufacture, such as one utilizing a communication system, may be tangibly embodied as or in the memory 1810, which may be or comprise a device-readable storage medium.

The processing circuitry 1802 may be configured to communicate with an access network or other network using the communication interface 1812. The communication interface 1812 may comprise one or more communication subsystems and may include or be communicatively coupled to an antenna 1822. The communication interface 1812 may include one or more transceivers used to communicate, such as by communicating with one or more remote transceivers of another device capable of wireless communication (e.g., another UE or a network node in an access network). Each transceiver may include a transmitter 1818 and/or a receiver 1820 appropriate to provide network communications (e.g., optical, electrical, frequency allocations, and so forth). Moreover, the transmitter 1818 and receiver 1820 may be coupled to one or more antennas (e.g., the antenna 1822) and may share circuit components, software, or firmware, or alternatively be implemented separately.

In the illustrated embodiment, communication functions of the communication interface 1812 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1800 shown in FIG. 18.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

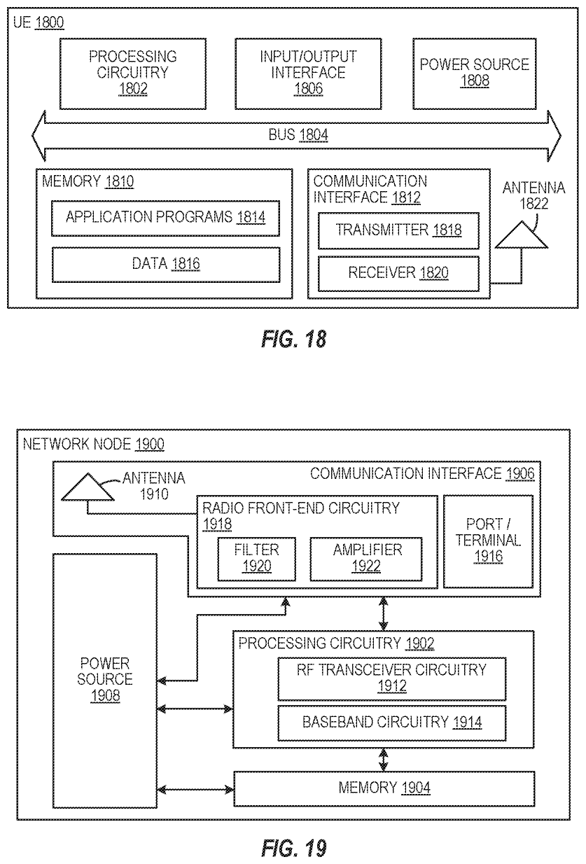

FIG. 19 shows a network node 1900 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), NR Node Bs (gNBs)), and O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node), and/or Remote Radio Units (RRUs), sometimes referred to as Remote Radio Heads (RRHs). Such RRUs may or may not be integrated with an antenna as an antenna integrated radio. Parts of a distributed radio base station may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1900 includes processing circuitry 1902, memory 1904, a communication interface 1906, and a power source 1908. The network node 1900 may be composed of multiple physically separate components (e.g., a NodeB component and an RNC component, or a BTS component and a BSC component, etc.), which may each have their own respective components. In certain scenarios in which the network node 1900 comprises multiple separate components (e.g., BTS and BSC components), one or more of the separate components may be shared among several network nodes. For example, a single RNC may control multiple NodeBs. In such a scenario, each unique NodeB and RNC pair may in some instances be considered a single separate network node. In some embodiments, the network node 1900 may be configured to support multiple RATs. In such embodiments, some components may be duplicated (e.g., separate memory 1904 for different RATs) and some components may be reused (e.g., a same antenna 1910 may be shared by different RATs). The network node 1900 may also include multiple sets of the various illustrated components for different wireless technologies integrated into network node 1900, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1900.

The processing circuitry 1902 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1900 components, such as the memory 1904, to provide network node 1900 functionality.

In some embodiments, the processing circuitry 1902 includes a System on a Chip (SOC). In some embodiments, the processing circuitry 1902 includes one or more of Radio Frequency (RF) transceiver circuitry 1912 and baseband processing circuitry 1914. In some embodiments, the RF transceiver circuitry 1912 and the baseband processing circuitry 1914 may be on separate chips (or sets of chips), boards, or units, such as radio units and digital units. In alternative embodiments, part or all of the RF transceiver circuitry 1912 and the baseband processing circuitry 1914 may be on the same chip or set of chips, boards, or units.

The memory 1904 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1902. The memory 1904 may store any suitable instructions, data, or information, including a computer program, software, an application including one or more of logic, rules, code, tables, and/or other instructions capable of being executed by the processing circuitry 1902 and utilized by the network node 1900. The memory 1904 may be used to store any calculations made by the processing circuitry 1902 and/or any data received via the communication interface 1906. In some embodiments, the processing circuitry 1902 and the memory 1904 are integrated.

The communication interface 1906 is used in wired or wireless communication of signaling and/or data between a network node, access network, and/or UE. As illustrated, the communication interface 1906 comprises port(s)/terminal(s) 1916 to send and receive data, for example to and from a network over a wired connection. The communication interface 1906 also includes radio front-end circuitry 1918 that may be coupled to, or in certain embodiments a part of, the antenna 1910. The radio front-end circuitry 1918 comprises filters 1920 and amplifiers 1922. The radio front-end circuitry 1918 may be connected to the antenna 1910 and the processing circuitry 1902. The radio front-end circuitry 1918 may be configured to condition signals communicated between the antenna 1910 and the processing circuitry 1902. The radio front-end circuitry 1918 may receive digital data that is to be sent out to other network nodes or UEs via a wireless connection. The radio front-end circuitry 1918 may convert the digital data into a radio signal having the appropriate channel and bandwidth parameters using a combination of the filters 1920 and/or the amplifiers 1922. The radio signal may then be transmitted via the antenna 1910. Similarly, when receiving data, the antenna 1910 may collect radio signals which are then converted into digital data by the radio front-end circuitry 1918. The digital data may be passed to the processing circuitry 1902. In other embodiments, the communication interface 1906 may comprise different components and/or different combinations of components.

In certain alternative embodiments, the network node 1900 does not include separate radio front-end circuitry 1918; instead, the processing circuitry 1902 includes radio front-end circuitry and is connected to the antenna 1910. Similarly, in some embodiments, all or some of the RF transceiver circuitry 1912 is part of the communication interface 1906. In still other embodiments, the communication interface 1906 includes the one or more ports or terminals 1916, the radio front-end circuitry 1918, and the RF transceiver circuitry 1912 as part of a radio unit (not shown), and the communication interface 1906 communicates with the baseband processing circuitry 1914, which is part of a digital unit (not shown).

The antenna 1910 may include one or more antennas, or antenna arrays, configured to send and/or receive wireless signals. The antenna 1910 may be coupled to the radio front-end circuitry 1918 and may be any type of antenna capable of transmitting and receiving data and/or signals wirelessly. In certain embodiments, the antenna 1910 is separate from the network node 1900 and connectable to the network node 1900 through an interface or port.

The antenna 1910, the communication interface 1906, and/or the processing circuitry 1902 may be configured to perform any receiving operations and/or certain obtaining operations described herein as being performed by the network node 1900. Any information, data, and/or signals may be received from a UE, another network node, and/or any other network equipment. Similarly, the antenna 1910, the communication interface 1906, and/or the processing circuitry 1902 may be configured to perform any transmitting operations described herein as being performed by the network node 1900. Any information, data, and/or signals may be transmitted to a UE, another network node, and/or any other network equipment.

The power source 1908 provides power to the various components of the network node 1900 in a form suitable for the respective components (e.g., at a voltage and current level needed for each respective component). The power source 1908 may further comprise, or be coupled to, power management circuitry to supply the components of the network node 1900 with power for performing the functionality described herein. For example, the network node 1900 may be connectable to an external power source (e.g., the power grid or an electricity outlet) via input circuitry or an interface such as an electrical cable, whereby the external power source supplies power to power circuitry of the power source 1908. As a further example, the power source 1908 may comprise a source of power in the form of a battery or battery pack which is connected to, or integrated in, power circuitry. The battery may provide backup power should the external power source fail.

Embodiments of the network node 1900 may include additional components beyond those shown in FIG. 19 for providing certain aspects of the network node's functionality, including any of the functionality described herein and/or any functionality necessary to support the subject matter described herein. For example, the network node 1900 may include user interface equipment to allow input of information into the network node 1900 and to allow output of information from the network node 1900. This may allow a user to perform diagnostic, maintenance, repair, and other administrative functions for the network node 1900.

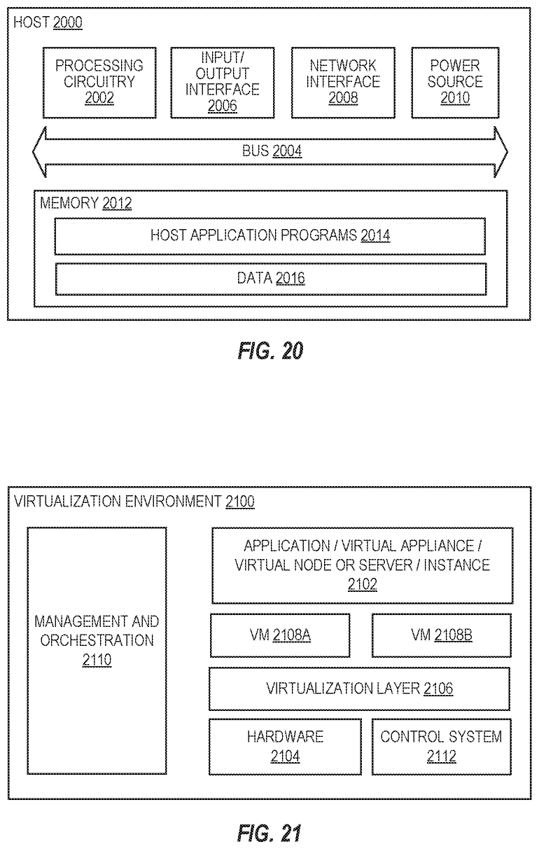

FIG. 20 is a block diagram of a host 2000, which may be an embodiment of the host 1716 of FIG. 17, in accordance with various aspects described herein. As used herein, the host 2000 may be or comprise various combinations of hardware and/or software including a standalone server, a blade server, a cloud-implemented server, a distributed server, a virtual machine, container, or processing resources in a server farm. The host 2000 may provide one or more services to one or more UEs.

The host 2000 includes processing circuitry 2002 that is operatively coupled via a bus 2004 to an input/output interface 2006, a network interface 2008, a power source 2010, and memory 2012. Other components may be included in other embodiments. Features of these components may be substantially similar to those described with respect to the devices of previous figures, such as FIGS. 18 and 19, such that the descriptions thereof are generally applicable to the corresponding components of the host 2000.

The memory 2012 may include one or more computer programs including one or more host application programs 2014 and data 2016, which may include user data, e.g. data generated by a UE for the host 2000 or data generated by the host 2000 for a UE. Embodiments of the host 2000 may utilize only a subset or all of the components shown. The host application programs 2014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 2014 may also provide for user authentication and licensing checks and may periodically report health, routes, and content availability to a central node, such as a device in or on the edge of a core network. Accordingly, the host 2000 may select and/or indicate a different host for Over-The-Top (OTT) services for a UE. The host application programs 2014 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

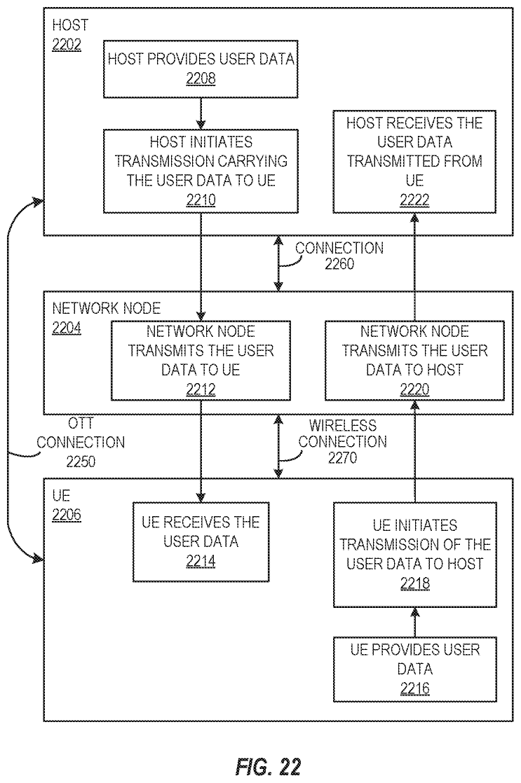

FIG. 21 is a block diagram illustrating a virtualization environment 2100 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2100 includes components defined by the O-RAN Alliance, such as an O-Cloud environment orchestrated by a Service Management and Orchestration Framework via an O-2 interface.

Applications 2102 (which may alternatively be called software instances, virtual appliances, network functions, virtual nodes, virtual network functions, etc.) are run in the virtualization environment 2100 to implement some of the features, functions, and/or benefits of some of the embodiments disclosed herein.

Hardware 2104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2106 (also referred to as hypervisors or VM Monitors (VMMs)), provide VMs 2108A and 2108B (one or more of which may be generally referred to as VMs 2108), and/or perform any of the functions, features, and/or benefits described in relation with some embodiments described herein. The virtualization layer 2106 may present a virtual operating platform that appears like networking hardware to the VMs 2108.

The VMs 2108 comprise virtual processing, virtual memory, virtual networking, or interface and virtual storage, and may be run by a corresponding virtualization layer 2106. Different embodiments of the instance of a virtual appliance 2102 may be implemented on one or more of the VMs 2108, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2108 may be a software implementation of a physical machine that runs programs as if they were executing on a physical, non-virtualized machine. Each of the VMs 2108, and that part of the hardware 2104 that executes that VM, be it hardware dedicated to that VM and/or hardware shared by that VM with others of the VMs 2108, forms separate virtual network elements. Still in the context of NFV, a virtual network function is responsible for handling specific network functions that run in one or more VMs 2108 on top of the hardware 2104 and corresponds to the application 2102.

The hardware 2104 may be implemented in a standalone network node with generic or specific components. The hardware 2104 may implement some functions via virtualization. Alternatively, the hardware 2104 may be part of a larger cluster of hardware (e.g., such as in a data center or CPE) where many hardware nodes work together and are managed via management and orchestration 2110, which, among others, oversees lifecycle management of the applications 2102. In some embodiments, the hardware 2104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a base station. In some embodiments, some signaling can be provided with the use of a control system 2112 which may alternatively be used for communication between hardware nodes and radio units.

FIG. 22 shows a communication diagram of a host 2202 communicating via a network node 2204 with a UE 2206 over a partially wireless connection in accordance with some embodiments. Example implementations, in accordance with various embodiments, of the UE (such as the UE 1712A of FIG. 17 and/or the UE 1800 of FIG. 18), the network node (such as the network node 1710A of FIG. 17 and/or the network node 1900 of FIG. 19), and the host (such as the host 1716 of FIG. 17 and/or the host 2000 of FIG. 20) discussed in the preceding paragraphs will now be described with reference to FIG. 22.

Like the host 2000, embodiments of the host 2202 include hardware, such as a communication interface, processing circuitry, and memory. The host 2202 also includes software, which is stored in or is accessible by the host 2202 and executable by the processing circuitry. The software includes a host application that may be operable to provide a service to a remote user, such as the UE 2206 connecting via an OTT connection 2250 extending between the UE 2206 and the host 2202. In providing the service to the remote user, a host application may provide user data which is transmitted using the OTT connection 2250.

The network node 2204 includes hardware enabling it to communicate with the host 2202 and the UE 2206. The connection 2260 may be direct or pass through a core network (like the core network 1706 of FIG. 17) and/or one or more other intermediate networks, such as one or more public, private, or hosted networks. For example, an intermediate network may be a backbone network or the Internet.

The UE 2206 includes hardware and software, which is stored in or accessible by the UE 2206 and executable by the UE's processing circuitry. The software includes a client application, such as a web browser or operator-specific “app” that may be operable to provide a service to a human or non-human user via the UE 2206 with the support of the host 2202. In the host 2202, an executing host application may communicate with the executing client application via the OTT connection 2250 terminating at the UE 2206 and the host 2202. In providing the service to the user, the UE's client application may receive request data from the host's host application and provide user data in response to the request data. The OTT connection 2250 may transfer both the request data and the user data. The UE's client application may interact with the user to generate the user data that it provides to the host application through the OTT connection 2250.

The OTT connection 2250 may extend via the connection 2260 between the host 2202 and the network node 2204 and via a wireless connection 2270 between the network node 2204 and the UE 2206 to provide the connection between the host 2202 and the UE 2206. The connection 2260 and the wireless connection 2270, over which the OTT connection 2250 may be provided, have been drawn abstractly to illustrate the communication between the host 2202 and the UE 2206 via the network node 2204, without explicit reference to any intermediary devices and the precise routing of messages via these devices.

As an example of transmitting data via the OTT connection 2250, in step 2208, the host 2202 provides user data, which may be performed by executing a host application. In some embodiments, the user data is associated with a particular human user interacting with the UE 2206. In other embodiments, the user data is associated with a UE 2206 that shares data with the host 2202 without explicit human interaction. In step 2210, the host 2202 initiates a transmission carrying the user data towards the UE 2206. The host 2202 may initiate the transmission responsive to a request transmitted by the UE 2206. The request may be caused by human interaction with the UE 2206 or by operation of the client application executing on the UE 2206. The transmission may pass via the network node 2204 in accordance with the teachings of the embodiments described throughout this disclosure. Accordingly, in step 2212, the network node 2204 transmits to the UE 2206 the user data that was carried in the transmission that the host 2202 initiated, in accordance with the teachings of the embodiments described throughout this disclosure. In step 2214, the UE 2206 receives the user data carried in the transmission, which may be performed by a client application executed on the UE 2206 associated with the host application executed by the host 2202.

In some examples, the UE 2206 executes a client application which provides user data to the host 2202. The user data may be provided in reaction or response to the data received from the host 2202. Accordingly, in step 2216, the UE 2206 may provide user data, which may be performed by executing the client application. In providing the user data, the client application may further consider user input received from the user via an input/output interface of the UE 2206. Regardless of the specific manner in which the user data was provided, the UE 2206 initiates, in step 2218, transmission of the user data towards the host 2202 via the network node 2204. In step 2220, in accordance with the teachings of the embodiments described throughout this disclosure, the network node 2204 receives user data from the UE 2206 and initiates transmission of the received user data towards the host 2202. In step 2222, the host 2202 receives the user data carried in the transmission initiated by the UE 2206.

One or more of the various embodiments improve the performance of OTT services provided to the UE 2206 using the OTT connection 2250, in which the wireless connection 2270 forms the last segment.

In an example scenario, factory status information may be collected and analyzed by the host 2202. As another example, the host 2202 may process audio and video data which may have been retrieved from a UE for use in creating maps. As another example, the host 2202 may collect and analyze real-time data to assist in controlling vehicle congestion (e.g., controlling traffic lights). As another example, the host 2202 may store surveillance video uploaded by a UE. As another example, the host 2202 may store or control access to media content such as video, audio, VR, or AR which it can broadcast, multicast, or unicast to UEs. As other examples, the host 2202 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2250 between the host 2202 and the UE 2206 in response to variations in the measurement results. The measurement procedure and/or the network functionality for reconfiguring the OTT connection 2250 may be implemented in software and hardware of the host 2202 and/or the UE 2206. In some embodiments, sensors (not shown) may be deployed in or in association with other devices through which the OTT connection 2250 passes; the sensors may participate in the measurement procedure by supplying values of the monitored quantities exemplified above, or by supplying values of other physical quantities from which software may compute or estimate the monitored quantities. The reconfiguring of the OTT connection 2250 may include message format, retransmission settings, preferred routing, etc.; the reconfiguring need not directly alter the operation of the network node 2204. Such procedures and functionalities may be known and practiced in the art. In certain embodiments, measurements may involve proprietary UE signaling that facilitates measurements of throughput, propagation times, latency, and the like by the host 2202. The measurements may be implemented in that software causes messages to be transmitted, in particular empty or ‘dummy’ messages, using the OTT connection 2250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

Some example embodiments of the present disclosure are as follows:

### Group A Embodiments

Embodiment 1: A method performed by a User Equipment, UE, for multi-Downlink Control Information, DCI, based multi-Transmission and Reception Point, TRP, uplink transmission, the method comprising any one (or both) of the following:
receiving a first PDCCH that carries a first DCI received in a Control Resource Set, CORESET, associated to a first CORESET pool index, wherein the first DCI either:
   schedules a first PUSCH for a multi-DCI based multi-TRP transmission; or
   activates a configured grant to be used by the first PUSCH for the multi-DCI based multi-TRP transmission; and
applying a first timing advance for transmission of the first PUSCH, the first timing advance corresponding to a first TAG being associated with any one (or more) of the following:
   a first Sounding Reference Signal, SRS, resource set associated to the first CORESET pool index;
   a first SRS Resource Indicator, SRI, PUSCH power control information element (e.g., associated to the first SRS resource set);
   a first list of SRI PUSCH power control information elements (e.g., associated to the first CORESET pool index);
   a first Physical Uplink Control Channel, PUCCH, power control set info information element;
   a single SRS resource set associated to both the first CORESET pool index and a second CORESET pool index, wherein a first subset of SRS resources in the single SRS resource set is associated to the first TAG.

Embodiment 2: The method of embodiment 1, further comprising any one (or more) of the following:
receiving a second PDCCH that carries a second DCI received in a CORESET associated to the second CORESET pool index, wherein the second DCI either:
   schedules a second PUSCH for the multi-DCI based multi-TRP transmission; or activates a configured grant to be used by the second PUSCH for the multi-DCI based multi-TRP transmission;
applying a second timing advance for transmission of the second PUSCH, the second timing advance corresponding to a second TAG being associated with any one (or more) of the following:
   a second SRS resource set associated to the second CORESET pool index;
   a second SRS Resource Indicator, SRI, PUSCH power control information element (e.g., associated to the second SRS resource set);
   a second list of SRI PUSCH power control information elements (e.g., associated to the second CORESET pool index);
   a second PUCCH power control set info information element;
   the single SRS resource set associated to both the first CORESET pool index and the second CORESET pool index, wherein a second subset of SRS resources in the single SRS resource set is associated to the second TAG, and the first subset of SRS resources and the second subset of SRS resources are different (e.g., non-overlapping) subsets of the single SRS resource set.

Embodiment 3: The method of embodiment 2, wherein the first TAG is associated with the first SRS resource set associated to the first CORESET pool index and the second TAG is associated with the second SRS resource set associated to the second CORESET pool index.

Embodiment 4: The method of embodiment 3, wherein a first TAG Identifier, ID, of the first TAG is explicitly configured in the first SRS resource set, and a second TAG ID of the second TAG is explicitly configured in the second SRS resource set.

Embodiment 5: The method of embodiment 3, wherein the first SRS resource set associated to the first CORESET pool index is implicitly associated to a first TAG Identifier, ID, of the first TAG, and the second SRS resource set associated to the second CORESET pool index is implicitly associated to a second TAG ID of the second TAG.

Embodiment 6: The method of embodiment 3, wherein a first TAG Identifier, ID, of the first TAG is configured in a serving cell configuration of a serving cell in which the first PUSCH is transmitted.

Embodiment 7: The method of embodiment 6, wherein the first TAG ID is associated with the first SRS resource set.

Embodiment 8: The method of embodiment 6 or 7, wherein a second TAG ID of the second TAG is configured in the second SRS resource set.

Embodiment 9: The method of embodiment 3, wherein a first TAG Identifier, ID, of the first TAG is configured in each SRS resource in the first SRS resource set, and a second TAG ID of the second TAG is configured in each SRS resource in the second SRS resource set.

Embodiment 10: The method of embodiment 3, wherein: the first DCI activates a type 1 configured grant to be used by the first PUSCH for the multi-DCI based multi-TRP transmission; and/or a first TAG Identifier, ID, of the first TAG is associated to an SRS resource in the first SRS resource set that is indicated by higher layer parameter “srs-ResourceIndicator” configured for type 1 CG PUSCH.

Embodiment 11: The method of embodiment 2, wherein the first TAG is configured in the first SRI PUSCH power control information element, and the second TAG is configured in the second SRI PUSCH power control information element.

Embodiment 12: The method of embodiment 2, wherein: the first TAG is configured in the first SRI PUSCH power control information element, and the first SRI PUSCH power control information element is associated to the first SRS resource set that is associated to the first CORESET pool index; and/or the second TAG is configured in the second SRI PUSCH power control information element, and the second SRI PUSCH power control information element is associated to the second SRS resource set that is associated to the second CORESET pool index.

Embodiment 13: The method of embodiment 2, wherein a first TAG ID of the first TAG is associated with a first list of SRI PUSCH power control elements, and a second TAG ID of the second TAG is associated with a second list of SRI PUSCH power control elements.

Embodiment 14: The method of embodiment 13, wherein the first list of SRI PUSCH power control elements is associated to the first CORESET pool index (e.g., in a field description of the first list), and the second list of SRI PUSCH power control elements is associated to the second CORESET pool index (e.g., in a field description of the first list).

Embodiment 15: The method of embodiment 13 or 14 wherein only one SRI PUSCH power control element in the first list is explicitly configured with the first TAG ID, and only one of SRI PUSCH power control element in the second list is explicitly configured with the second TAG ID.

Embodiment 16: The method of embodiment 2, wherein a first TAG ID of the first TAG is implicitly associated with a first list of SRI PUSCH power control elements which is associated to the first CORESET pool index, and a second TAG ID of the second TAG is implicitly associated with a second list of SRI PUSCH power control elements which is associated to the second CORESET pool index.

Embodiment 17: The method of any of the previous embodiments, further comprising: providing user data; and forwarding the user data to a host via the transmission to the network node.

### Group B Embodiments

Embodiment 18: A method performed by one or more network nodes for enabling multi-Downlink Control Information, DCI, based multi-Transmission and Reception Point, TRP, uplink transmission, the method comprising any one (or more) of the following:
transmitting a first PDCCH to a User Equipment, UE, wherein the first PDCCH carries a first DCI in a Control Resource Set, CORESET, associated to a first CORESET pool index, wherein the first DCI either:
   schedules a first PUSCH for a multi-DCI based multi-TRP transmission; or activates a configured grant to be used by the first PUSCH for the multi-DCI based multi-TRP transmission; and
wherein a first timing advance for transmission of the first PUSCH by the UE corresponds to a first TAG associated with any one (or more) of the following:
   the first Sounding Reference Signal, SRS, resource set associated to the first CORESET pool index;
   a first SRS Resource Indicator, SRI, PUSCH power control information element (e.g., associated to the first SRS resource set);
   a first list of SRI PUSCH power control information elements (e.g., associated to the first CORESET pool index);
   a first Physical Uplink Control Channel, PUCCH, power control set info information element;
   a single SRS resource set associated to both the first CORESET pool index and a second CORESET pool index, wherein a first subset of SRS resources in the single SRS resource set is associated to the first TAG.

Embodiment 19: The method of embodiment 18, further comprising any one (or more) of the following:
transmitting, to the UE, a second PDCCH that carries a second DCI received in a CORESET associated to the second CORESET pool index, wherein the second DCI either:
   schedules a second PUSCH for the multi-DCI based multi-TRP transmission; or activates a configured grant to be used by the second PUSCH for the multi-DCI based multi-TRP transmission;
wherein a second timing advance for transmission of the second PUSCH by the UE corresponds to a second TAG associated with any one (or more) of the following:
   the second SRS resource set associated to the second CORESET pool index;
   a second SRS Resource Indicator, SRI, PUSCH power control information element (e.g., associated to the second SRS resource set);
   a second list of SRI PUSCH power control information elements (e.g., associated to the second CORESET pool index);
   a second PUCCH power control set info information element;
   the single SRS resource set associated to both the first CORESET pool index and the second CORESET pool index, wherein a second subset of SRS resources in the single SRS resource set is associated to the second TAG, and the first subset of SRS resources and the second subset of SRS resources are different (e.g., non-overlapping) subsets of the single SRS resource set.

Embodiment 20: The method of any of the previous embodiments, further comprising: obtaining user data; and forwarding the user data to a host or a user equipment.

### Group C Embodiments

Embodiment 21: A user equipment comprising: processing circuitry configured to perform any of the steps of any of the Group A embodiments; and power supply circuitry configured to supply power to the processing circuitry.

Embodiment 22: A network node comprising: processing circuitry configured to perform any of the steps of any of the Group B embodiments; and power supply circuitry configured to supply power to the processing circuitry.

Embodiment 23: A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 24: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 25: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 26: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 27: The method of the previous embodiment, further comprising, at the network node, transmitting the user data provided by the host for the UE.

Embodiment 28: The method of any of the previous 2 embodiments, wherein the user data is provided at the host by executing a host application that interacts with a client application executing on the UE, the client application being associated with the host application.

Embodiment 29: A communication system configured to provide an over-the-top (OTT) service, the communication system comprising a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 30: The communication system of the previous embodiment, further comprising: the network node; and/or the UE.

Embodiment 31: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 32: The host of the previous 2 embodiments, wherein: the processing circuitry of the host is configured to execute a host application that receives the user data; and the host application is configured to interact with a client application executing on the UE, the client application being associated with the host application.

Embodiment 33: The host of the any of the previous 2 embodiments, wherein the initiating receipt of the user data comprises requesting the user data.

Embodiment 34: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 35: The method of the previous embodiment, further comprising at the network node, transmitting the received user data to the host.

Embodiment 36: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the operations of any of the Group A embodiments to receive the user data from the host.

Embodiment 37: The host of the previous embodiment, wherein the cellular network further includes a network node configured to communicate with the UE to transmit the user data to the UE from the host.

Embodiment 38: The host of the previous 2 embodiments, wherein: the processing circuitry of the host is configured to execute a host application, thereby providing the user data; and the host application is configured to interact with a client application executing on the UE, the client application being associated with the host application.

Embodiment 39: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 40: The method of the previous embodiment, further comprising: at the host, executing a host application associated with a client application executing on the UE to receive the user data from the host application.

Embodiment 41: The method of the previous embodiment, further comprising: at the host, transmitting input data to the client application executing on the UE, the input data being provided by executing the host application, wherein the user data is provided by the client application in response to the input data from the host application.

Embodiment 42: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

Embodiment 43: The host of the previous embodiment, wherein the cellular network further includes a network node configured to communicate with the UE to transmit the user data from the UE to the host.

Embodiment 44: The host of the previous 2 embodiments, wherein: the processing circuitry of the host is configured to execute a host application, thereby providing the user data; and the host application is configured to interact with a client application executing on the UE, the client application being associated with the host application.

Embodiment 45: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 46: The method of the previous embodiment, further comprising: at the host, executing a host application associated with a client application executing on the UE to receive the user data from the UE.

Embodiment 47: The method of the previous 2 embodiments, further comprising: at the host, transmitting input data to the client application executing on the UE, the input data being provided by executing the host application, wherein the user data is provided by the client application in response to the input data from the host application.

Those skilled in the art will recognize improvements and modifications to the embodiments of the present disclosure. All such improvements and modifications are considered within the scope of the concepts disclosed herein.

1. A method performed by a User Equipment, UE, the method comprising:
receiving a first Downlink Control Information, DCI, in a first Control Resource Set, CORESET, associated to a first CORESET pool index, wherein the first CORESET pool index is associated to a first time advanced group, TAG, identifier, ID, and:
the first DCI either schedules transmission of a first Physical Uplink Shared Channel, PUSCH, or activates a configured grant for transmission of the first PUSCH;
the UE is configured with a first Sounding Reference Signal, SRS, resource set that is associated to the first CORESET pool index; and
an SRS Resource Indicator, SRI, field in the first DCI indicates an SRS resource in the first SRS resource set;
receiving a second DCI in a second CORESET associated to a second CORESET pool index, wherein the second CORESET pool index is associated to a second time advanced group, TAG, identifier, ID, and:
the second DCI either schedules transmission of a second PUSCH or activates a configured grant for transmission of the second PUSCH;
the UE is configured with a second SRS resource set that is associated to the second CORESET pool index; and
an SRI field in the second DCI indicates an SRS resource in the second SRS resource set;
transmitting the first PUSCH in accordance with the first DCI and the first TAG identifier; and
transmitting the second PUSCH in accordance with the second DCI and the second TAG identifier.

2. The method of claim 1, wherein the first CORESET pool index is 0, and the second CORESET pool index is 1.

3. The method of claim 2, wherein the first SRS resource set has a smaller SRS resource set identifier than that of the second SRS resource set.

4. The method of claim 1, wherein the first SRS resource set associated to the first CORESET pool index is associated to the first TAG ID, and the second SRS resource set associated to the second CORESET pool index is associated to the second TAG ID.

5. The method of claim 1, further comprising transmitting SRS resources in the first SRS resource set according to the first TAG ID and transmitting SRS resources in the second SRS resource set according to the second TAG ID.

6. The method of claim 1, further comprising receiving a first and a second time advance, TA, values associated to the first and the second TAG IDs, respectively.

7. The method of claim 1, wherein the transmitting according to the first or the second TAG ID comprises applying a time advance according to the first or the second TA value.

8. The method of claim 1, wherein the first SRS resource set associated to the first CORESET pool index is associated to a first Timing Advance Group, TAG, and the second SRS resource set associated to the second CORESET pool index is associated to a second TAG, wherein the first SRS resource set has a lower SRS resource set index than the second SRS resource set, and the first TAG is a TAG configured for the first CORESET pool index, the first CORESET pool index being 0.

9. A User Equipment, UE, adapted to:
receive a first Downlink Control Information, DCI, in a first Control Resource Set, CORESET, associated to a first CORESET pool index, wherein the first CORESET pool index is associated to a first time advanced group, TAG, identifier and:
the first DCI either schedules transmission of a first Physical Uplink Shared Channel, PUSCH, or activates a configured grant for transmission of the first PUSCH;
the UE is configured with a first Sounding Reference Signal, SRS, resource set that is associated to the first CORESET pool index; and
an SRS Resource Indicator, SRI, field in the first DCI indicates an SRS resource in the first SRS resource set;
receive a second DCI in a second CORESET associated to a second CORESET pool index, wherein the second CORESET pool index is associated to a second time advanced group, TAG, identifier and:
the second DCI either schedules transmission of a second PUSCH or activates a configured grant for transmission of the second PUSCH;
the UE is configured with a second SRS resource set that is associated to the second CORESET pool index; and
an SRI field in the second DCI indicates an SRS resource in the second SRS resource set;
transmit the first PUSCH in accordance with the first DCI and the first TAG identifier; and
transmit the second PUSCH, in accordance with the second DCI and the second TAG identifier.

10. The UE of claim 9, wherein the first CORESET pool index is 0, and the second CORESET pool index is 1.

11. The UE of claim 10, wherein the first SRS resource set has a smaller SRS resource index than that of the second SRS resource set.

12. The UE of claim 9, wherein the first SRS resource set associated to the first CORESET pool index is associated to a first Timing Advance Group, TAG, Identifier, ID, and the second SRS resource set associated to the second CORESET pool index is associated to a second TAG ID.

13. The UE of claim 9, further comprising transmitting SRS resources in the first SRS resource set according to the first TAG identifier and transmitting SRS resources in the second SRS resource set according to the second TAG identifier.

14-15. (canceled)

16. The UE of claim 9, wherein the first SRS resource set associated to the first CORESET pool index is associated to a first Timing Advance Group, TAG, and the second SRS resource set associated to the second CORESET pool index is associated to a second TAG, wherein the first SRS resource set has a lower SRS resource set index than the second SRS resource set, and the first TAG is a TAG configured for the first CORESET pool index, the first CORESET pool index being 0.

17-24. (canceled)

25. A method performed by one or more network nodes, the method comprising:
transmitting to a User Equipment, UE, a first Downlink Control Information, DCI, in a first Control Resource Set, CORESET, associated to a first CORESET pool index, wherein the first CORESET pool index is associated to a first time advanced group, TAG, identifier and:
the first DCI either schedules transmission of a first Physical Uplink Shared Channel, PUSCH, or activates a configured grant for transmission of the first PUSCH;
the UE is configured with a first Sounding Reference Signal, SRS, resource set that is associated to the first CORESET pool index; and
an SRS Resource Indicator, SRI, field in the first DCI indicates an SRS resource in the first SRS resource set;
transmitting to the UE a second DCI in a second CORESET associated to a second CORESET pool index, wherein the second CORESET pool index is associated to a second time advanced group, TAG, identifier and:
the second DCI either schedules transmission of a second PUSCH or activates a configured grant for transmission of the second PUSCH;
the UE is configured with a second SRS resource set that is associated to the second CORESET pool index; and
an SRI field in the second DCI indicates an SRS resource in the second SRS resource set.

26. The method of claim 25, wherein the first CORESET pool index is 0, and the second CORESET pool index is 1.

27. The method of claim 26, wherein the first SRS resource set has a smaller SRS resource index than that of the second SRS resource set.

28. The method of claim 25, wherein the first SRS resource set associated to the first CORESET pool index is associated to a first Timing Advance Group, TAG, Identifier, ID, and the second SRS resource set associated to the second CORESET pool index is associated to a second TAG ID.

29. The method of claim 25, further comprising transmitting, to the UE, a first and a second time advance, TA, values associated to the first and the second TAG IDs, respectively.

30. The method of claim 25, wherein the first SRS resource set associated to the first CORESET pool index is associated to a first Timing Advance Group, TAG, and the second SRS resource set associated to the second CORESET pool index is associated to a second TAG, wherein the first SRS resource set has a lower SRS resource set index than the second SRS resource set, and the first TAG is a TAG configured for the first CORESET pool index, the first CORESET pool index being 0.
